(19) United States
(12) Patent Application Publication
(10) Pub. No.: US 2026/0177188 A1
(43) Pub. Date: Jun. 25, 2026

(54) DISPLAY APPARATUS

(71) Applicant: SAMSUNG ELECTRONICS CO., LTD., Suwon-si (KR)

(72) Inventor: Wookjin LEE, Suwon-si (KR)

(73) Assignee: SAMSUNG ELECTRONICS CO., LTD., Suwon-si (KR)

(21) Appl. No.: 19/386,931

(22) Filed: Nov. 12, 2025

Related U.S. Application Data
(63) Continuation of application No. PCT/KR2025/017671, filed on Oct. 31, 2025.

(30) Foreign Application Priority Data
Dec. 24, 2024 (KR) 10-2024-0196041

(51) Int. Cl. F16M 11/04; G09F 9/302; G09F 9/33

(52) U.S. Cl. CPC F16M 11/041; G09F 9/3026; G09F 9/33

(57) ABSTRACT

A display apparatus may include a frame; a light-emitting diode (LED) module including a tapered pin assembled to the frame; and a ball clamp coupled to the frame and to which the tapered pin is assembled. The ball clamp may include a case including a first inclined surface; a ball holder movably inside the case in a first direction in which the tapered pin is inserted and/or a second direction in which the tapered pin is removed; a magnet attached to the ball holder and configured to move the ball holder in the first or second direction by a magnetic force; and balls in the ball holder and configured to move along the first inclined surface to hold and/or release the tapered pin when the ball holder moves in the first or second direction.

### CROSS-REFERENCE TO RELATED APPLICATIONS

This application is a bypass continuation of International Patent Application No. PCT/KR2025/017671, filed on October 31, 2025, which claims priority to Korean Patent Application No. 10-2024-0196041, filed in the Korean Intellectual Property Office on December 24, 2024, the disclosures of which are herein incorporated by reference in their entireties.

### BACKGROUND

### 1. Field

The disclosure relates to a display apparatus that is improved to facilitate the assembly and disassembly of a light-emitting diode (LED) module while maintaining a strong holding force of the LED module.

### 2. Description of Background Art

In general, a display apparatus is a device that displays a screen, and includes monitors and televisions. A display apparatus is a type of output device that converts acquired or stored electrical information into visual information and displays such information to a user, and is used in various fields such as homes and businesses.

A display apparatus may include a monitor device connected to a personal computer (PC), a server computer, a handheld computer device, a navigation terminal device, a conventional television device, an internet protocol television (IPTV) device, a portable terminal device (e.g., a smartphone, tablet PC, personal digital assistants (PDA), or cellular phone), various display devices used to play images (e.g., advertisements or movies in industrial sites), or various other types of audio/video systems.

A display device may include a plurality of display modules to form a single screen. The plurality of display modules forming a single screen may be assembled into a frame to form the display apparatus.

### SUMMARY

An embodiment of the disclosure may include a display apparatus that is improved to facilitate the assembly and/or disassembly of an LED module.

An embodiment of the disclosure may include a display apparatus that is improved to maintain a strong holding force of an LED module assembled to a frame.

An embodiment of the present disclosure may include a display apparatus in which an LED module may be assembled to a frame or disassembled from the frame by magnetic force of a magnet.

An embodiment of the present disclosure may include a display apparatus in which an LED module may be disassembled from a frame by rotation of a knob.

According to an aspect of the disclosure, a display apparatus may include: a frame; a light-emitting diode (LED) module including a tapered pin; and a ball clamp configured to connect the frame and the LED module by the tapered pin being inserted into the ball clamp in a first direction; wherein the ball clamp includes: a case including a first inclined surface; a ball holder configured to move inside the case in the first direction or a second direction, opposite to the first direction, based on the tapered pin being inserted into the ball clamp in the first direction or removed from the ball clamp in the second direction; a magnet attached to the ball holder and configured to move the ball holder in the first direction or the second direction by a magnetic force; a plurality of balls in the ball holder, the plurality of balls configured to hold the tapered pin by the plurality of balls moving along the first inclined surface when the ball holder moves in the second direction, or release the tapered pin by the plurality of balls moving along the first inclined surface when the ball holder moves in the first direction; and a knob configured to allow, based on the knob being rotated, the ball holder to move in the first direction to cause the plurality of balls to release the tapered pin .

According to an aspect of the disclosure, a display apparatus may include: a frame; a light-emitting diode (LED) module including a tapered pin, the tapered pin including a magnetic material; and a ball clamp configured to connect the frame and the LED module by the tapered pin being inserted into the ball clamp in a first direction, wherein the ball clamp includes: a case including a first inclined surface; a ball holder configured to move inside the case in the first direction or a second direction, opposite to the first direction, based on the tapered pin being inserted into the ball clamp in the first direction or removed from the ball clamp in the second direction; a first magnet attached to the ball holder and configured to move the ball holder in the first direction or the second direction by a magnetic force, and a plurality of balls in the ball holder, the plurality of balls configured to hold the tapered pin by the plurality of balls moving along the first inclined surface when the ball holder moves in the second direction, or release the tapered pin by the plurality of balls moving along the first inclined surface when the ball holder moves in the first direction, wherein the plurality of balls are in a circular arrangement, and wherein the plurality of balls are configured to hold the tapered pin based on a diameter of the circular arrangement decreasing, or release the tapered pin based on the diameter of the circular arrangement increasing.

Aspects and effects of embodiments of the disclosure are not limited to the aspects and effects mentioned above, and other unmentioned aspects and effects of embodiments of the disclosure will be clearly understood by those skilled in the art from the description below.

### BRIEF DESCRIPTION OF DRAWINGS

FIG. 1 is a perspective view illustrating a front surface of a display apparatus according to an embodiment.

FIG. 2 is a view illustrating a state in which an LED module is assembled to a frame according to an embodiment.

FIG. 3 is an enlarged view of a portion A shown in FIG. 2.

FIG. 4 is an enlarged view of a portion B shown in FIG. 2.

FIG. 5 is a perspective view illustrating a ball clamp according to an embodiment.

FIG. 6 is a view illustrating a ball clamp and a tapered pin disassembled according to an embodiment.

FIG. 7 is a perspective view illustrating a ball holder according to an embodiment.

FIG. 8 is a perspective view illustrating a state in which a case and a coupling body are coupled according to an embodiment.

FIG. 9 is a perspective view illustrating a state in which the ball holder and a connection body are coupled according to an embodiment.

FIG. 10 is a perspective view illustrating a state in which the connection body and a knob are connected according to an embodiment.

FIG. 11 is a view illustrating a first contact surface of the knob and a second contact surface of the coupling body according to an embodiment.

FIG. 12 is a view illustrating a state of assembling the LED module to a frame according to an embodiment.

FIG. 13 is a cross-sectional view illustrating a state in which the tapered pin of the LED module is inserted into the ball clamp of the frame according to an embodiment.

FIG. 14 is a cross-sectional view illustrating a state in which the ball holder has been moved in a first direction by pushing a plurality of balls as the tapered pin shown in FIG. 13 is inserted into the ball clamp.

FIG. 15 is a cross-sectional view illustrating a state in which the ball holder shown in FIG. 14 has moved in a second direction by a magnetic force.

FIG. 16 is a view illustrating a state of positioning a magnet on a front surface of the LED module so as to disassemble the LED module assembled to the frame using the magnet according to an embodiment.

FIG. 17 is a cross-sectional view illustrating a state in which the ball holder has been moved in a first direction by positioning the magnet on the front surface of the LED module assembled to the frame according to an embodiment.

FIG. 18 is a cross-sectional view illustrating a state in which the LED module is disassembled from the frame according to an embodiment.

FIG. 19 is a view illustrating a state in which the LED module is assembled to the frame and the knob is in a locked state, according to an embodiment.

FIG. 20 is a cross-sectional view illustrating a state in which a first contact surface of the knob and a second contact surface of the coupling body are in contact when the knob is in the locked state, according to an embodiment.

FIG. 21 is a view illustrating a state in which the LED module is assembled to the frame and the knob is in an unlocked state after being rotated from the locked state, according to an embodiment.

FIG. 22 is a cross-sectional view illustrating a state in which the first contact surface of the knob and the second contact surface of the coupling body are in contact when the knob is in the unlocked state, according to an embodiment.

FIG. 23 is a cross-sectional view illustrating a state in which the ball holder has moved in a first direction by the knob when the knob is in the unlocked state, according to an embodiment.

FIG. 24 is a view illustrating a state of disassembling the LED module from the frame when the knob is in the unlocked state, according to an embodiment.

FIG. 25 is a cross-sectional view illustrating a state of disassembling the LED module from the frame when the knob is in the unlocked state, according to an embodiment.

FIG. 26 is a view illustrating a state in which the LED module is disassembled from the frame when the knob is in an unlocked state, according to an embodiment.

### DETAILED DESCRIPTION

Example embodiments of the disclosure and terms used in the disclosure are not intended to limit the disclosure to specific embodiments, and the disclosure should be understood to include various modifications, equivalents, or substitutes of the corresponding example embodiments.

In connection with the description of the drawings, similar reference numerals may be used for similar or related components.

Also, the terms used herein are used to describe non-limiting example embodiments and are not intended to limit and/or restrict the disclosure. The singular forms “a,” “an,” and “the” are intended to include the plural forms as well, unless the context clearly indicates otherwise. In this disclosure, the terms “including,” “comprising,” “having,” and the like are used to specify features, figures, steps, operations, elements, components, or combinations thereof, but do not preclude the presence or addition of one or more of the features, figures, steps, operations, elements, components, or combinations thereof.

In the disclosure, phrases, such as “A or B,” “at least one of A and B,” “at least one of A or B,” “A, B or C,” “at least one of A, B and C,” and “at least one of A, B, or C” may include any one or all possible combinations of the items listed together in the corresponding phrase among the phrases.

The term of “and/or” includes a plurality of combinations of relevant items or any one item among a plurality of relevant items.

It will be understood that, although the terms “first,” “second,” “primary,” “secondary,” etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In addition, in the disclosure, the meaning of “identical” includes cases where properties are similar to each other or similar within a certain range. Furthermore, identical means “substantially identical”. The meaning of substantially identical should be understood to include numerical values within manufacturing error ranges or differences within a range that is insignificant with respect to a reference numerical value as falling within the scope of “identical.”

In addition, terms such as “part,” “portion,” “unit,” “block,” “member,” “module,” and the like, may refer to a unit that processes at least one function or operation. For example, these terms may refer to at least one hardware (e.g., a field-programmable gate array (FPGA) or application specific integrated circuit (ASIC)), at least one software stored in memory.

Meanwhile, terms used in the following description such as “front,” “rear,” “left,” and “right,” and the like, are defined based on the drawings, and the shape and position of each element are not limited by these terms.

Hereinafter, various non-limiting example embodiments of the disclosure will be described in detail with reference to the accompanying drawings.

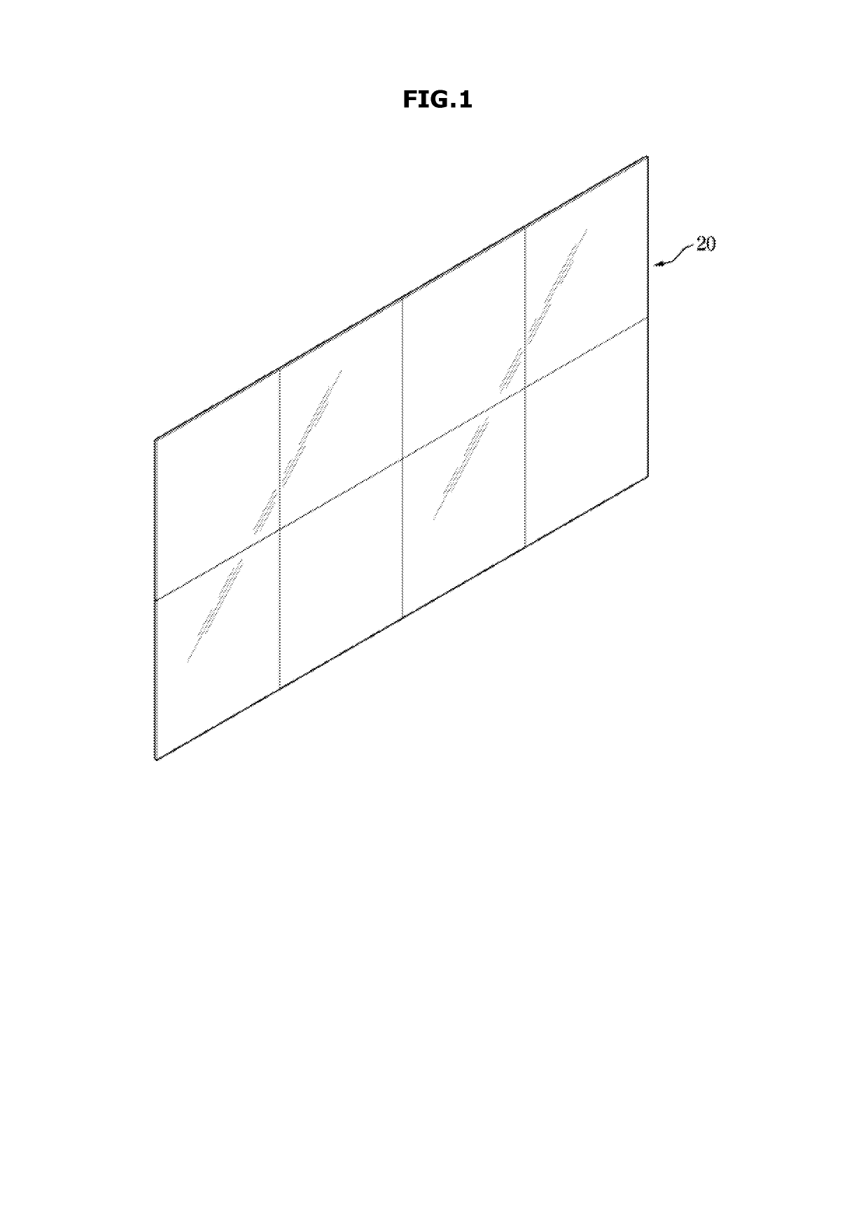

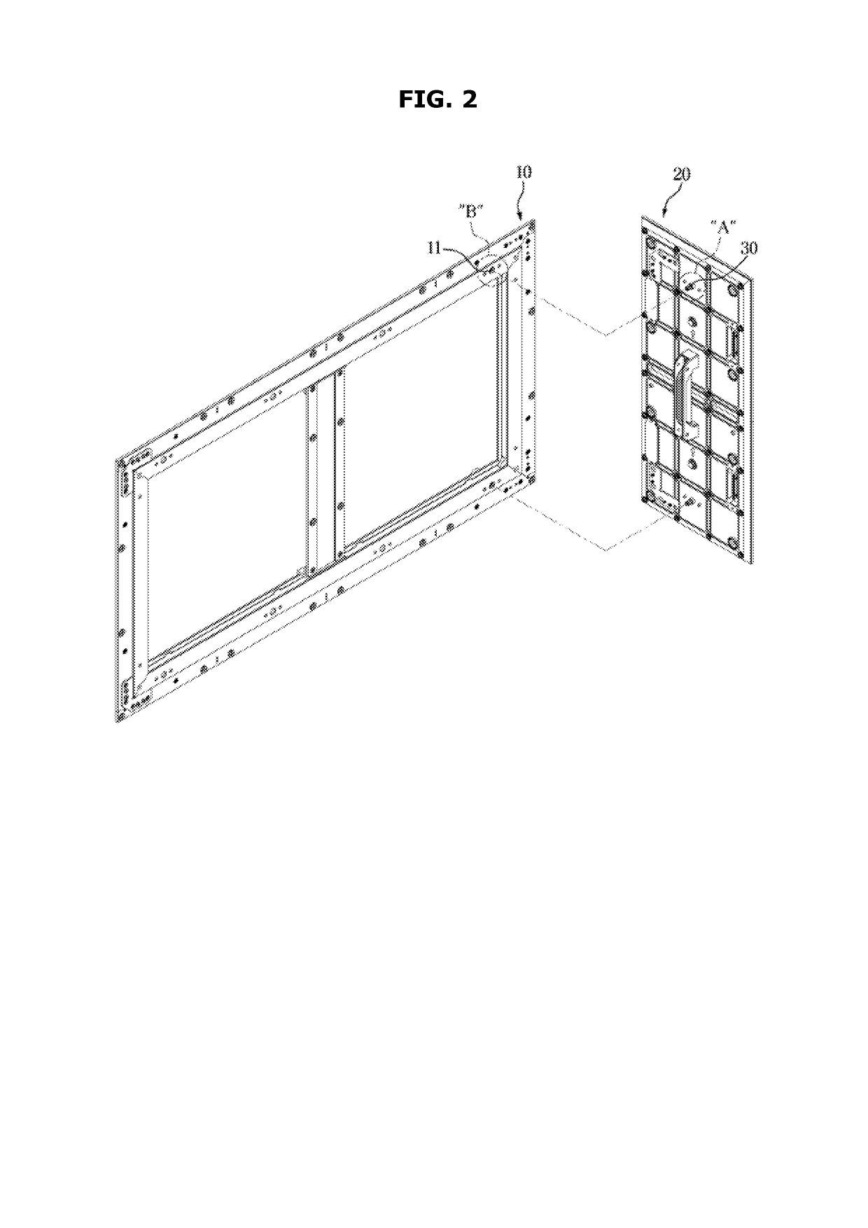

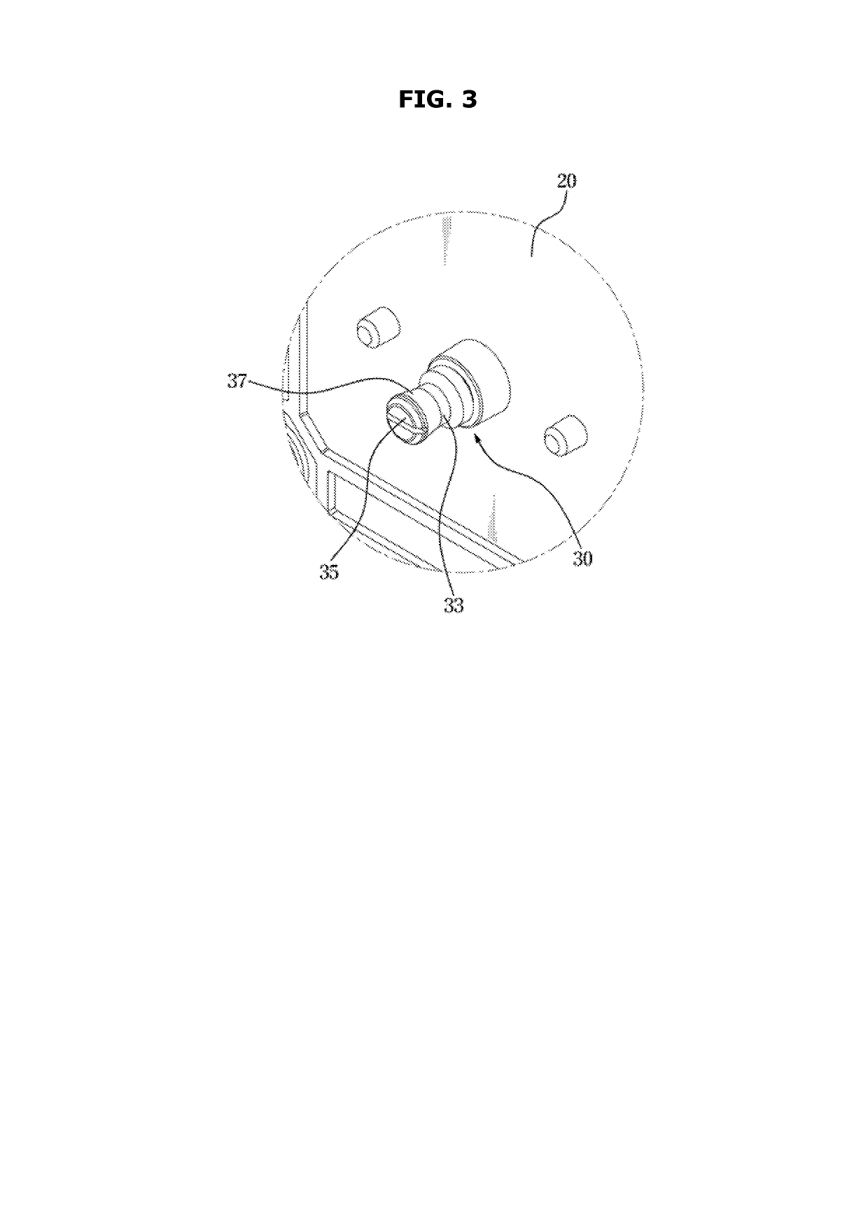

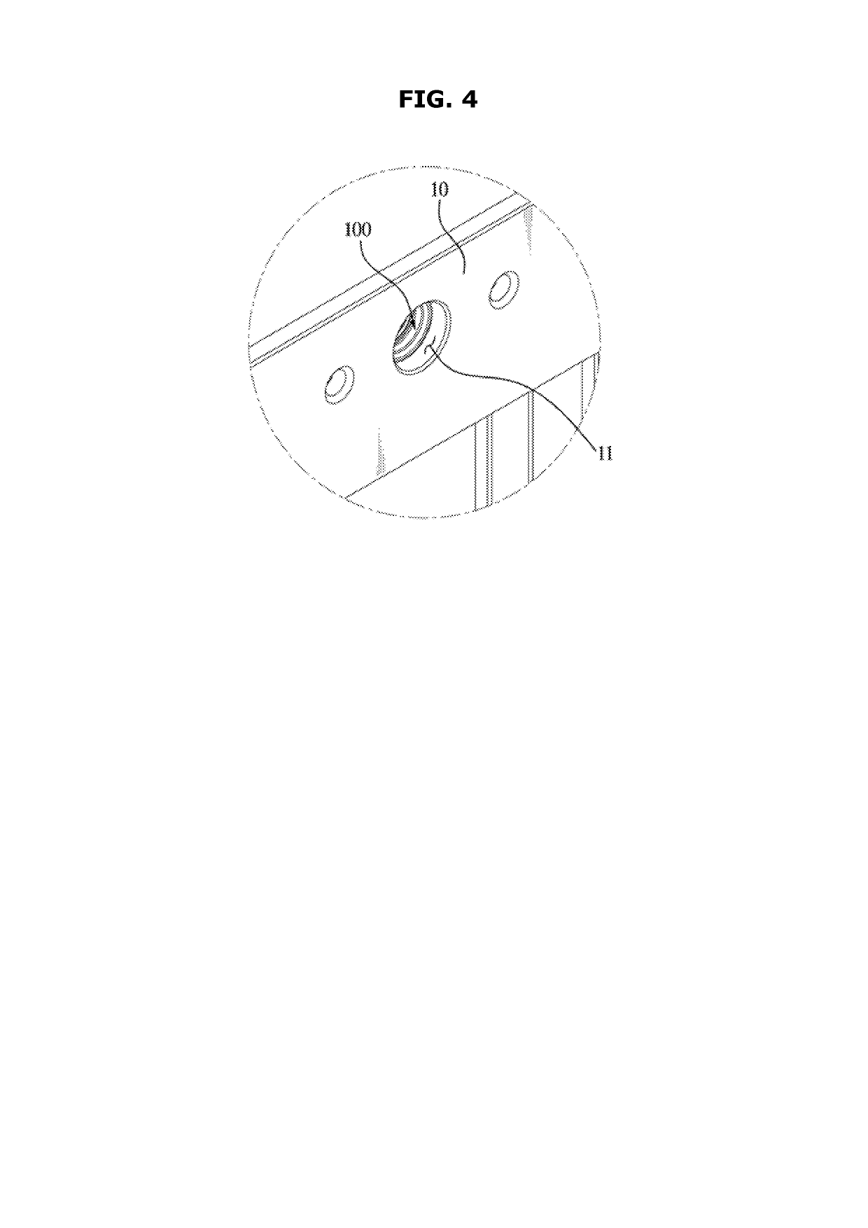

FIG. 1 is a perspective view illustrating a front surface of a display apparatus according to an embodiment. FIG. 2 is a view illustrating a state in which a light-emitting diode (LED) module is assembled to a frame according to an embodiment. FIG. 3 is an enlarged view of a portion A shown in FIG. 2. FIG. 4 is an enlarged view of a portion B shown in FIG. 2.

As shown in FIGS. 1 to 4, a display apparatus may include a frame 10 and a plurality of LED modules 20 assembled to the frame 10. Each of the plurality of LED modules 20 may output an image. The plurality of LED modules 20 may be assembled on the frame 10 to form a single screen. Although four LED modules 20 are shown assembled on the frame 10, embodiments of the disclosure are not limited thereto. For example, three or fewer LED modules 20 may be assembled on the frame 10 to form a display apparatus. Alternatively, five or more LED modules 20 may be assembled on the frame 10 to form a display apparatus.

The frame 10 may include at least one ball clamp coupling hole 11. The frame 10 may be coupled with at least one ball clamp 100 to which the plurality of LED modules 20 are assembled. The ball clamp 100 may be coupled to the ball clamp coupling hole 11. The ball clamp coupling hole 11 may be formed to penetrate the frame 10. A portion of the ball clamp 100 may be received within the ball clamp coupling hole 11. The ball clamp coupling hole 11 may have a larger diameter at a rear end of the ball clamp coupling hole 11 than the diameter at a front end of the ball clamp coupling hole 11 where the plurality of LED modules 20 are assembled.

Each of the plurality of LED modules 20 may include a tapered pin 30 that is assembled to a respective one of the ball clamps 100. Each of the plurality of LED modules 20 may include a pair of tapered pins 30. The pair of tapered pins 30 may be coupled to an upper portion and a lower portion, respectively, of each of the plurality of LED modules 20. A plurality of the ball clamps 100 may be provided to have a number corresponding to the number of the tapered pins 30 of the plurality of LED modules 20.

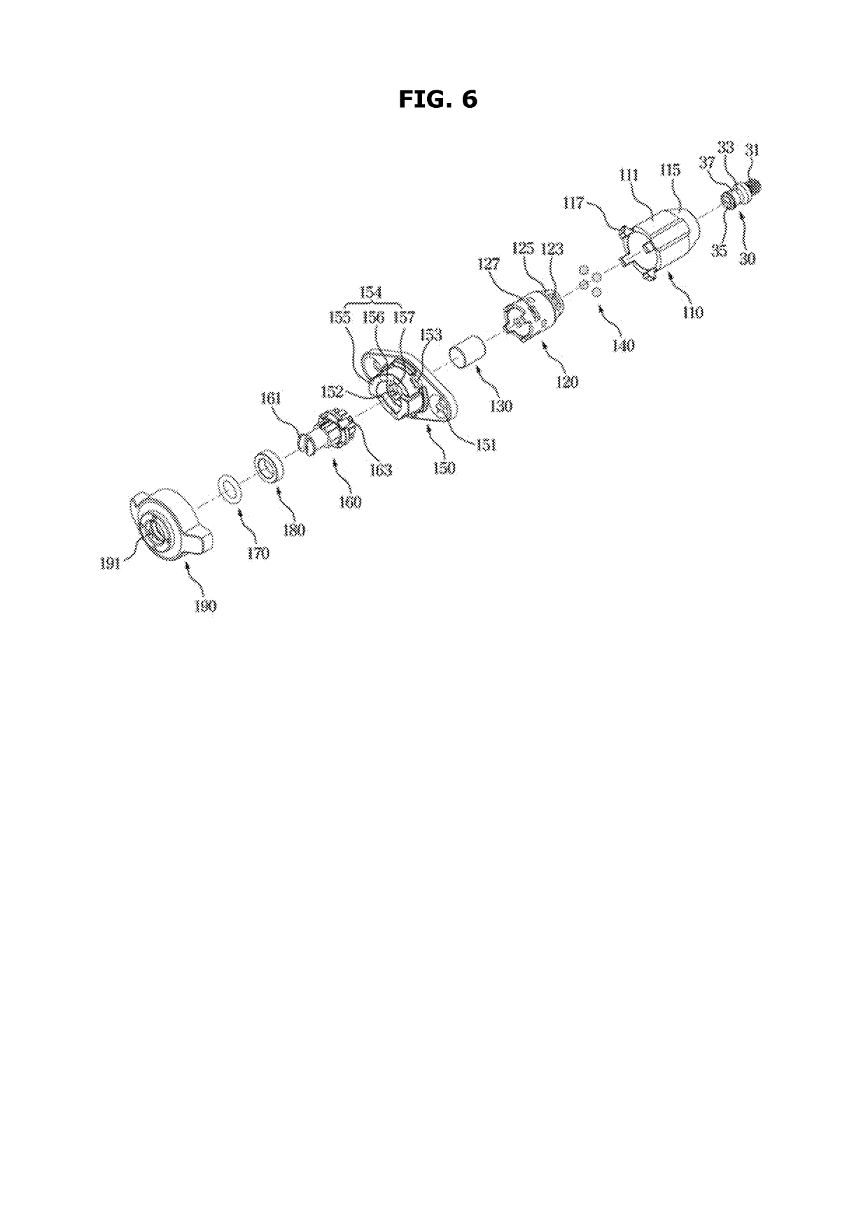

The tapered pins 30 may be coupled to the rear surface of the plurality of LED modules 20. The tapered pin 30 may be formed of a magnetic material. The tapered pin 30 may be formed of a magnetic material such that a first magnet 130 attached to a ball holder 120, which will be described later, may be attached to the tapered pin 30 by magnetic force (see FIG. 6).

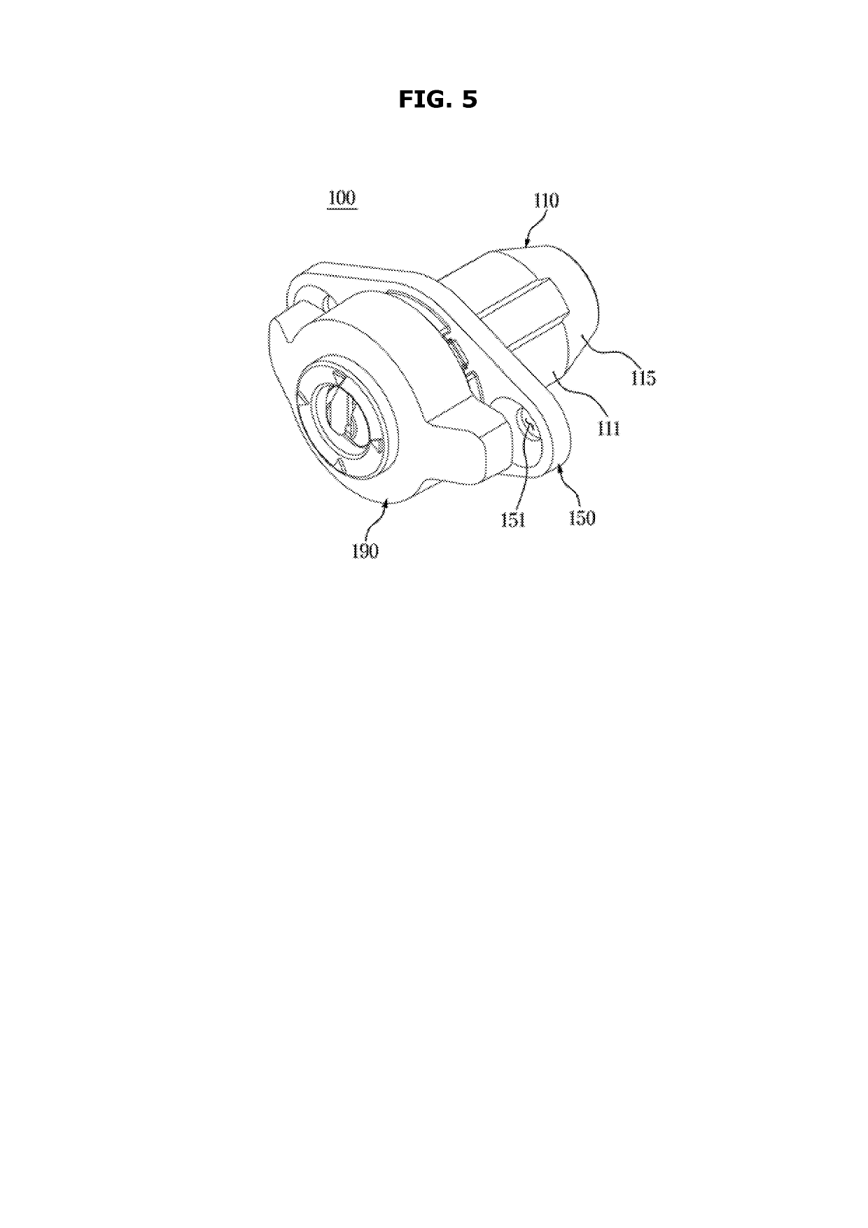

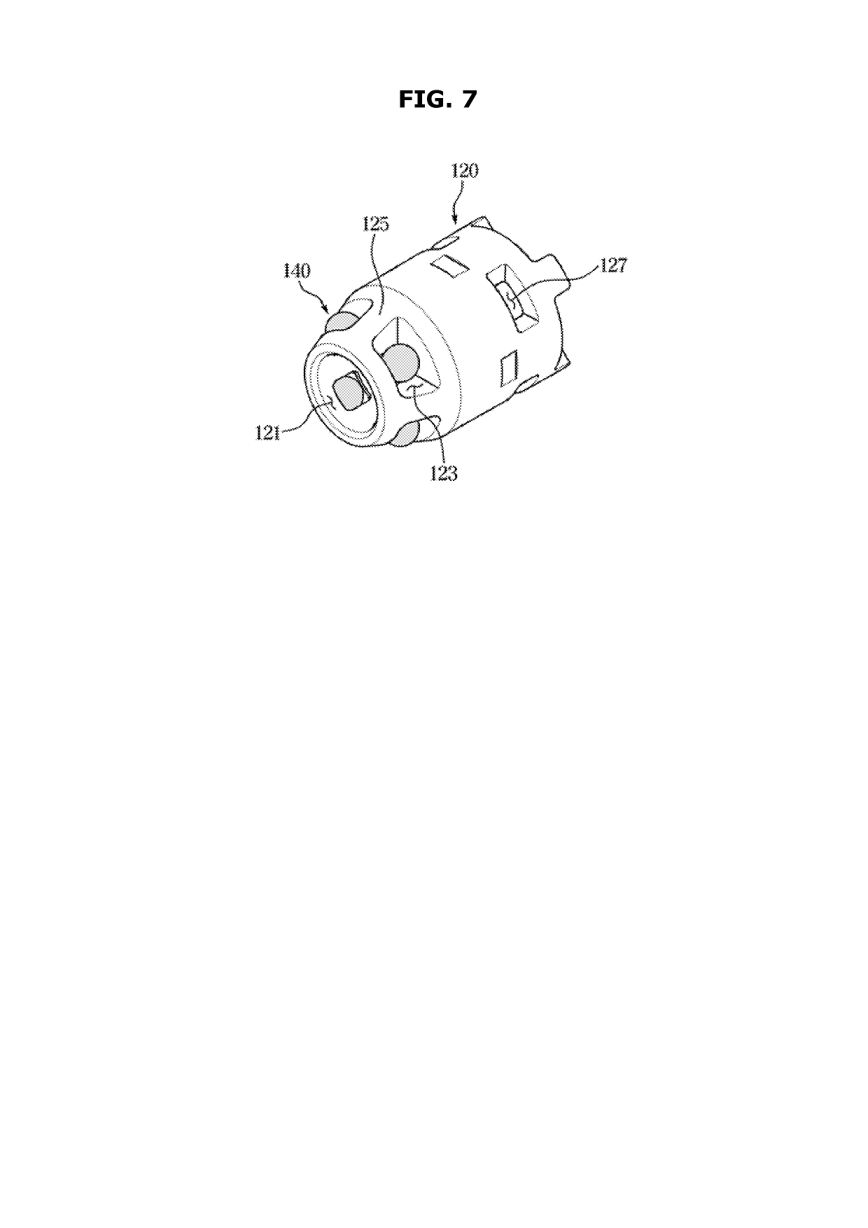

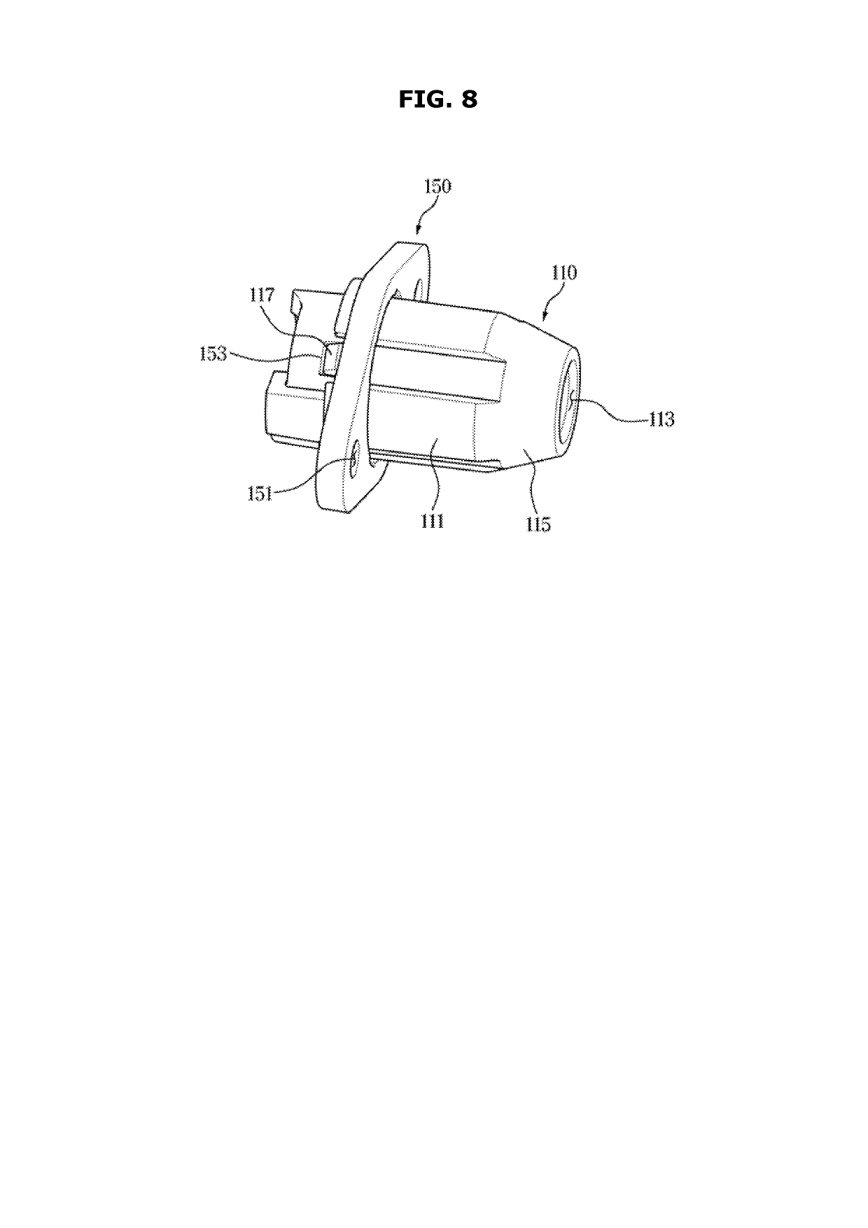

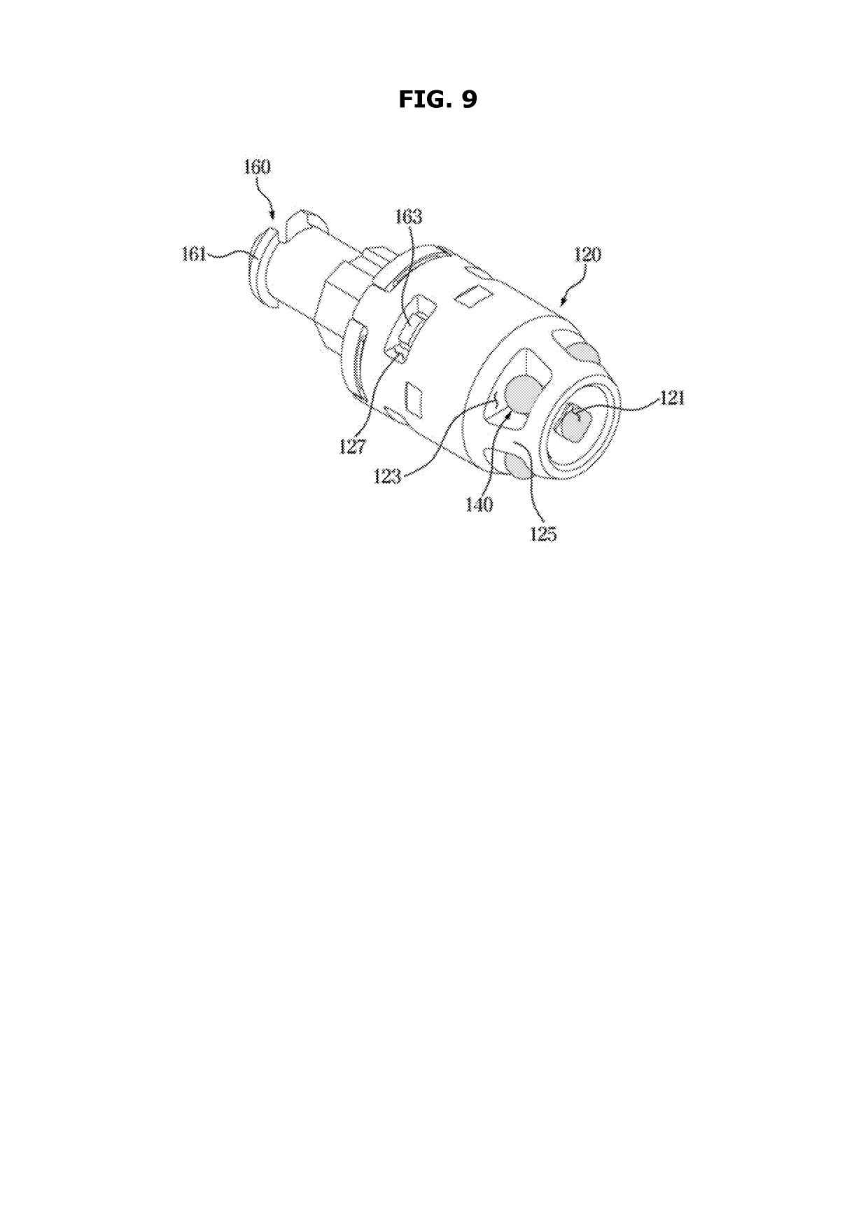

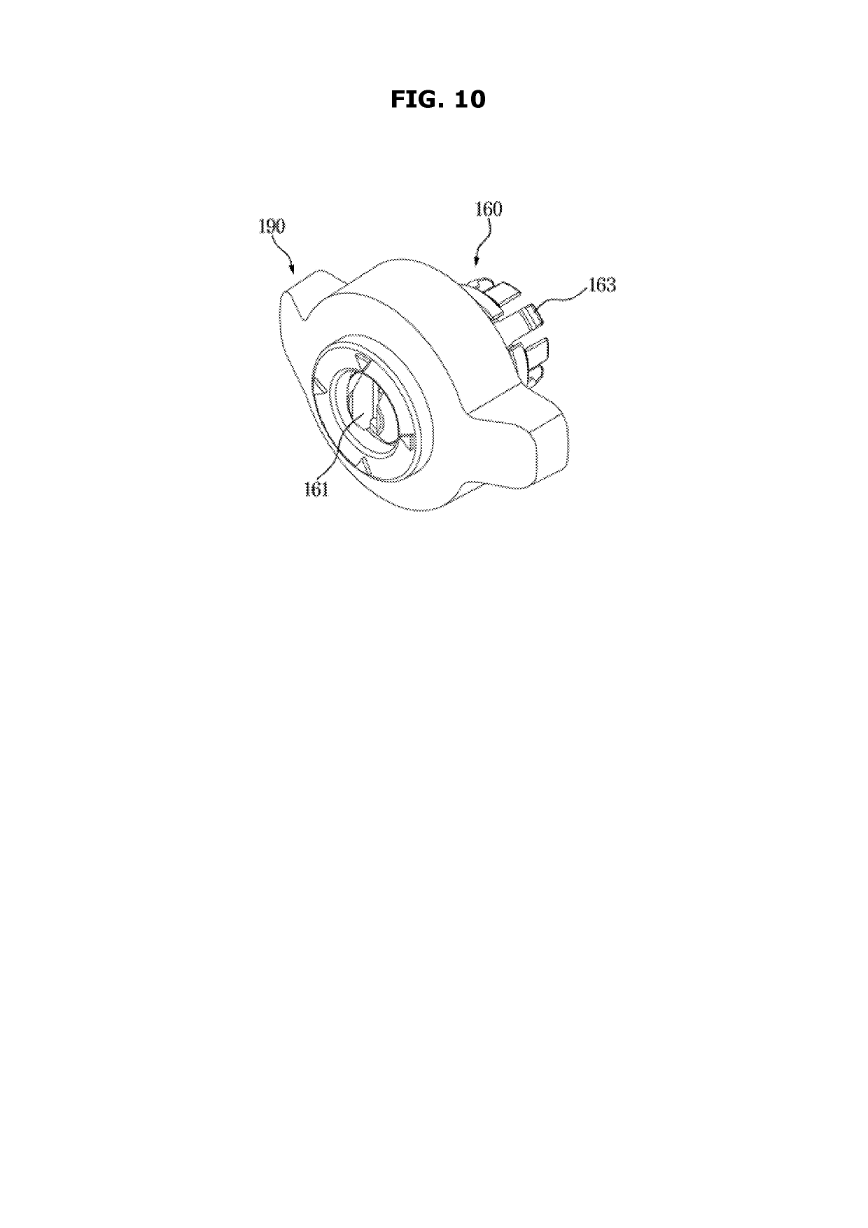

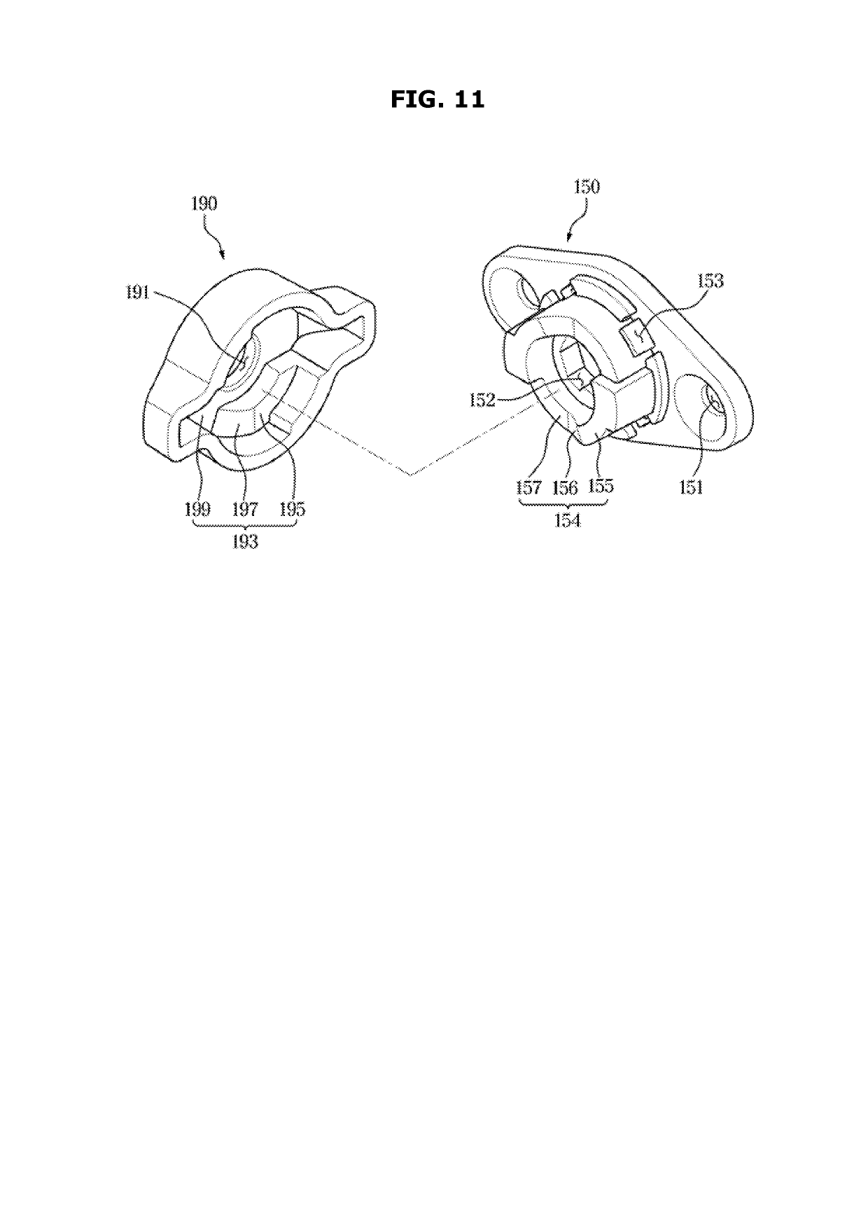

FIG. 5 is a perspective view illustrating a ball clamp according to an embodiment. FIG. 6 is a view illustrating a ball clamp and a tapered pin disassembled according to an embodiment. FIG. 7 is a perspective view illustrating a ball holder according to an embodiment. FIG. 8 is a perspective view illustrating a state in which a case and a coupling body are coupled according to an embodiment. FIG. 9 is a perspective view illustrating a state in which the ball holder and a connection body are coupled according to an embodiment. FIG. 10 is a perspective view illustrating a state in which the connection body and a knob are connected according to an embodiment. FIG. 11 is a view illustrating a first contact surface of the knob and a second contact surface of the coupling body according to an embodiment.

As shown in FIGS. 5 to 11, the tapered pin 30 may include a coupling portion 31. The coupling portion 31 may be coupled to the LED module 20. The coupling portion 31 may be coupled to the rear surface of the LED module 20. The coupling portion 31 may not be exposed to an outside when the coupling portion 31 is coupled to the rear surface of the LED module 20.

The tapered pin 30 may include an insertion portion 33. When the LED module 20 is assembled to the frame 10, the insertion portion 33 may be inserted into a first insertion hole 113 of a case 110, which will be described later. A portion of the insertion portion 33 may be inserted into a second insertion hole 121 of the ball holder 120, which will be described later.

The tapered pin 30 may include a push portion 35. The push portion 35 may be formed in the insertion portion 33. The push portion 35 may be formed on a front surface of the insertion portion 33 based on a direction in which the insertion portion 33 is inserted into the first insertion hole 113 of the case 110. When the insertion portion 33 is inserted into the first insertion hole 113 of the case 110 resulting in a portion of the insertion portion 33 being inserted into the second insertion hole 121 of the ball holder 120, the push portion 35 may push a plurality of balls 140, which will be described later.

The tapered pin 30 may include a tapered portion 37. The tapered portion 37 may have a tapered shape. The tapered portion 37 may be formed in the insertion portion 33. The tapered portion 37 may be formed on a rear side of the push portion 35 based on a direction in which the insertion portion 33 is inserted into a first insertion hole 113 of the case 110. The tapered portion 37 may be formed such that a diameter thereof gradually decreases in a direction away from the push portion 35. When the tapered pin 30 is assembled to the ball clamp 100 of the frame 10, the tapered portion 37 may be a portion that is held by the plurality of balls 140.

The ball clamp 100 may be coupled to the frame 10. The ball clamp 100 may be coupled to the ball clamp coupling hole 11 of the frame 10. A portion of the ball clamp 100 coupled to the ball clamp coupling hole 11 may be exposed to the outside. The tapered pin 30 coupled to the LED module 20 may be assembled to the ball clamp 100. The plurality of LED modules 20 may be assembled on the frame 10 by at least one tapered pin 30 coupled to at least one LED module 20 being assembled to at least one ball clamp 100 (see FIGS. 2 and 4).

The ball clamp 100 may include the case 110. The ball holder 120 may be accommodated inside the case 110. The case 110 may include a case body 111 positioned inside the ball clamp coupling hole 11 when the ball clamp 100 is coupled to the ball clamp coupling hole 11 of the frame 10. In other words, when the ball clamp 100 is coupled to the ball clamp coupling hole 11 of the frame 10, the case body 111 may be positioned inside the frame 10 (see FIGS. 2 and 4).

The case 110 may include a first insertion hole 113. The first insertion hole 113 may be open in a direction facing the LED module 20 in the case body 111. The first insertion hole 113 may be formed in a front side of the case 110. The first insertion hole 113 may be formed in a front side of the case body 111. Here, the front side may be a front surface side of the frame 10 where the plurality of LED modules 20 are assembled. The first insertion hole 113 may be exposed to the outside through the ball clamp coupling hole 11 formed in the frame 10. The tapered pin 30 coupled to the LED module 20 may be inserted into the first insertion hole 113. The insertion portion 33 of the tapered pin 30 may be inserted into the first insertion hole 113 (see FIGS. 2 and 4).

The case 110 may include a first inclined surface 115. The first inclined surface 115 may be formed on the front side of the case 110. The first inclined surface 115 may be formed on the front side of the case body 111. Here, the front side may be the front surface side of the frame 10 where the plurality of LED modules 20 are assembled. The first inclined surface 115 may be formed such that a diameter thereof gradually increases in a direction toward a rear side of the case body 111 from the first insertion hole 113 formed in the front side of the case body 111 (see FIG. 2).

The case 110 may include a plurality of first assembly hooks 117. The plurality of first assembly hooks 117 may be formed on a side of the case body 111 that is opposite to a side of the case body 111 in which the first insertion hole 113 is formed. The plurality of first assembly hooks 117 may be formed on the rear side of the case 110. The plurality of first assembly hooks 117 may be formed on the rear side of the case body 111. The plurality of first assembly hooks 117 may be connected (e.g., assembled) to a coupling body 150, which will be described later. By the plurality of first assembly hooks 117 being connected (e.g., assembled) to the coupling body 150, the case 110 may be connected (e.g., assembled) to the coupling body 150.

The ball clamp 100 may include the ball holder 120. The ball holder 120 may be received within the case 110. The ball holder 120 may be provided to be movable in a first direction and/or a second direction inside the case 110. Here, the first direction may be a direction in which the tapered pin 30 is inserted. The second direction may be a direction in which the tapered pin 30 is disassembled.

The ball holder 120 may include a second insertion hole 121. The second insertion hole 121 may be formed at a position corresponding to the first insertion hole 113 formed in the case 110. The tapered pin 30 may be inserted into the second insertion hole 121. A portion of the insertion portion 33 of the tapered pin 30 may be inserted into the second insertion hole 121.

The ball holder 120 may include a receiving hole 123. The receiving hole 123 may be formed in a second inclined surface 125 of the ball holder 120, which will be described later. A plurality of receiving holes 123 may be provided. Although four receiving holes 123 are shown in the drawings, embodiments of the disclosure are not limited thereto. For example, three or fewer receiving holes 123 may be formed, or five or more receiving holes 123 may be formed. The plurality of balls 140 may be received in the receiving holes 123. For example, one respective ball 140 may be received in each of the plurality of receiving holes 123.

The receiving hole 123 may be formed to penetrate the ball holder 120 from the inside to the outside. The receiving hole 123 may be formed to be larger at a portion located towards the outside of the ball holder 120 than at a portion located towards the inside of the ball holder 120. In other words, the portion of the receiving hole 123 (e.g., an inner or innermost portion of the receiving hole 123) that is located towards the inside the ball holder 120 may be formed to be smaller than a diameter of the ball 140. Since the portion of the receiving hole 123 located towards the inside the ball holder 120 is formed to be smaller than the diameter of the ball 140, the ball 140 may be positioned in the receiving hole 123 so as not to move into the inside of the ball holder 120. The portion of the receiving hole 123 (e.g., an outer or outermost portion of the receiving hole 123) located towards the outside the ball holder 120 may be formed to be larger than the diameter of the ball 140. Since the portion of the receiving hole 123 located towards the outside the ball holder 120 is formed to be larger than the diameter of the ball 140, the ball 140 may positioned in the receiving hole 123 so as to be able to move to the outside of the ball holder 120. The ball 140 received in the receiving hole 123 may contact the first inclined surface 115 of the case 110 through the portion of the receiving hole 123 located towards the outside the ball holder 120. When the ball holder 120 moves in the first direction and/or the second direction inside the case 110, the plurality of balls 140 may move along the first inclined surface 115 of the case 110.

The ball holder 120 may include a second inclined surface 125. The second inclined surface 125 may be formed to correspond to the first inclined surface 115 of the case 110. The second inclined surface 125 may be formed such that a diameter thereof gradually increases in a direction toward a rear side of the ball holder 120 from the second insertion hole 121 formed on a front side of the ball holder 120. The plurality of receiving holes 123 may be formed in the second inclined surface 125.

The ball holder 120 may include a plurality of second assembly holes 127. A connection body 160, which will be described later, may be connected (e.g., assembled) to the plurality of second assembly holes 127. A plurality of second assembly hooks 163 formed on the connection body 160 may be connected (e.g., assembled) to the plurality of second assembly holes 127. Since the connection body 160 is connected (e.g., assembled) to the ball holder 120, when the ball holder 120 is moved in the first direction and/or the second direction inside the case 110, the connection body 160 may also be moved in the first direction and/or the second direction together with the ball holder 120.

The ball clamp 100 may include the first magnet 130. The first magnet 130 may be attached to the ball holder 120. The first magnet 130 may be attached to an inside of the ball holder 120. Since the tapered pin 30 is formed of a magnetic material, the first magnet 130 attached to the ball holder 120 may be moved in a direction toward the tapered pin 30 by magnetic force. Since the first magnet 130 moves in a direction toward the tapered pin 30 by magnetic force, the ball holder 120, to which the first magnet 130 is attached, may also move in a direction toward the tapered pin 30. In other words, the ball holder 120 may move in the second direction by the magnetic force of the first magnet 130.

The ball clamp 100 may include the plurality of balls 140. The plurality of balls 140 may be received in the plurality of receiving holes 123 formed in the ball holder 120. The plurality of balls 140 and the plurality of receiving holes 123 may be formed in corresponding numbers. The plurality of balls 140 provided in the ball holder 120 may move along the first inclined surface 115 of the case 110 when the ball holder 120 moves in the first direction and/or the second direction. The plurality of balls 140 may move in the first direction and/or the second direction along the first inclined surface 115 of the case 110 to hold and/or release the tapered pin 30. In other words, the plurality of balls 140 may be moved along the first inclined surface 115 of the case 110 to adjust a diameter of a circle formed by the plurality of balls 140. Since the plurality of balls 140 move along the first inclined surface 115 of the case 110, the diameter of the circle formed by the plurality of balls 140 may be adjusted to gradually increase when the ball holder 120 is moved in the first direction. As the diameter of the circle formed by the plurality of balls 140 increases, the tapered pin 30 may be inserted between the plurality of balls 140. In addition, when the ball holder 120 is moved in the second direction, the diameter of the circle formed by the plurality of balls 140 may be adjusted to gradually decrease. As the diameter of the circle formed by the plurality of balls 140 decreases, the tapered pin 30 inserted between the plurality of balls 140 may be held by the plurality of balls 140.

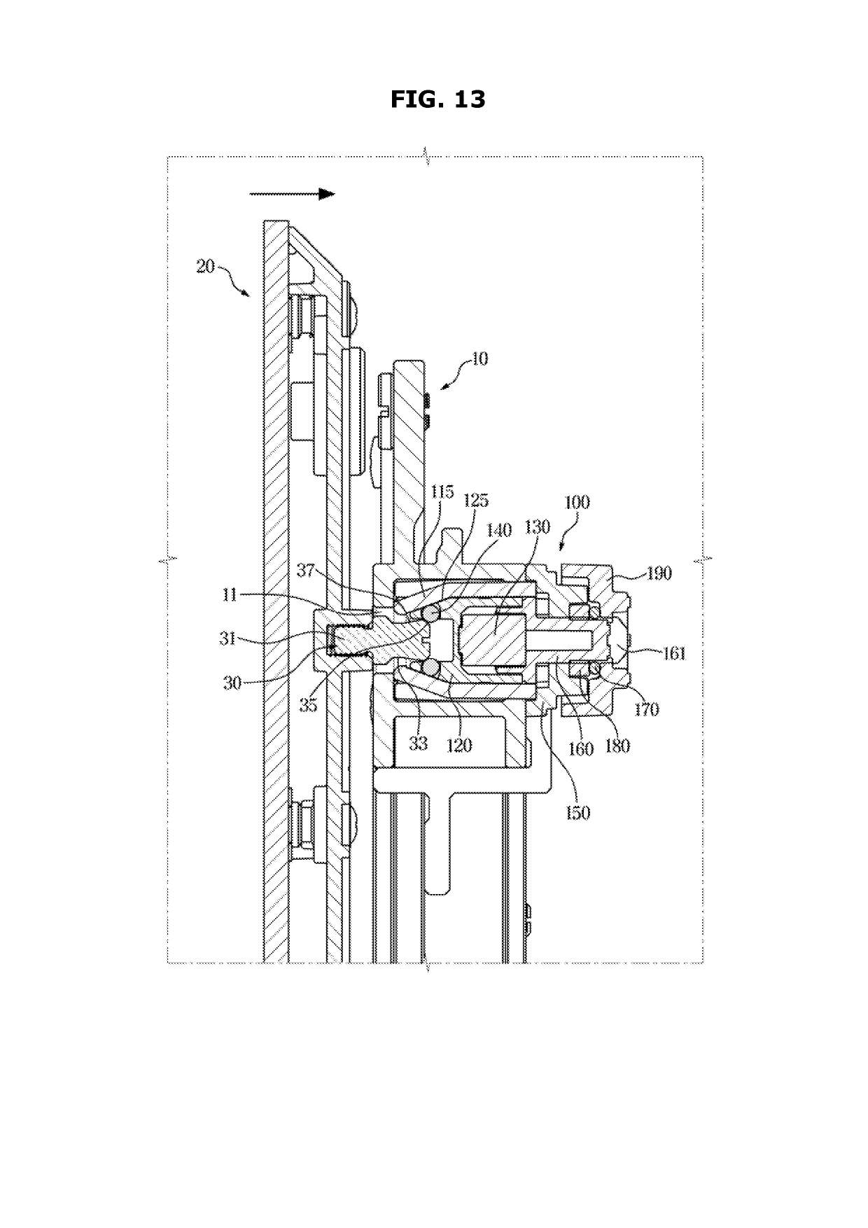

The ball clamp 100 may include the coupling body 150. The coupling body 150 may be coupled to the frame 10. The coupling body 150 may be coupled to the rear surface of the frame 10. The coupling body 150 may be coupled to an outer side of the frame 10. The coupling body 150 may be coupled to an outer side of the ball clamp coupling hole 11 of the frame 10. The coupling body 150 may be coupled to the outer side of the frame 10 and exposed to the outside (see FIG. 13).

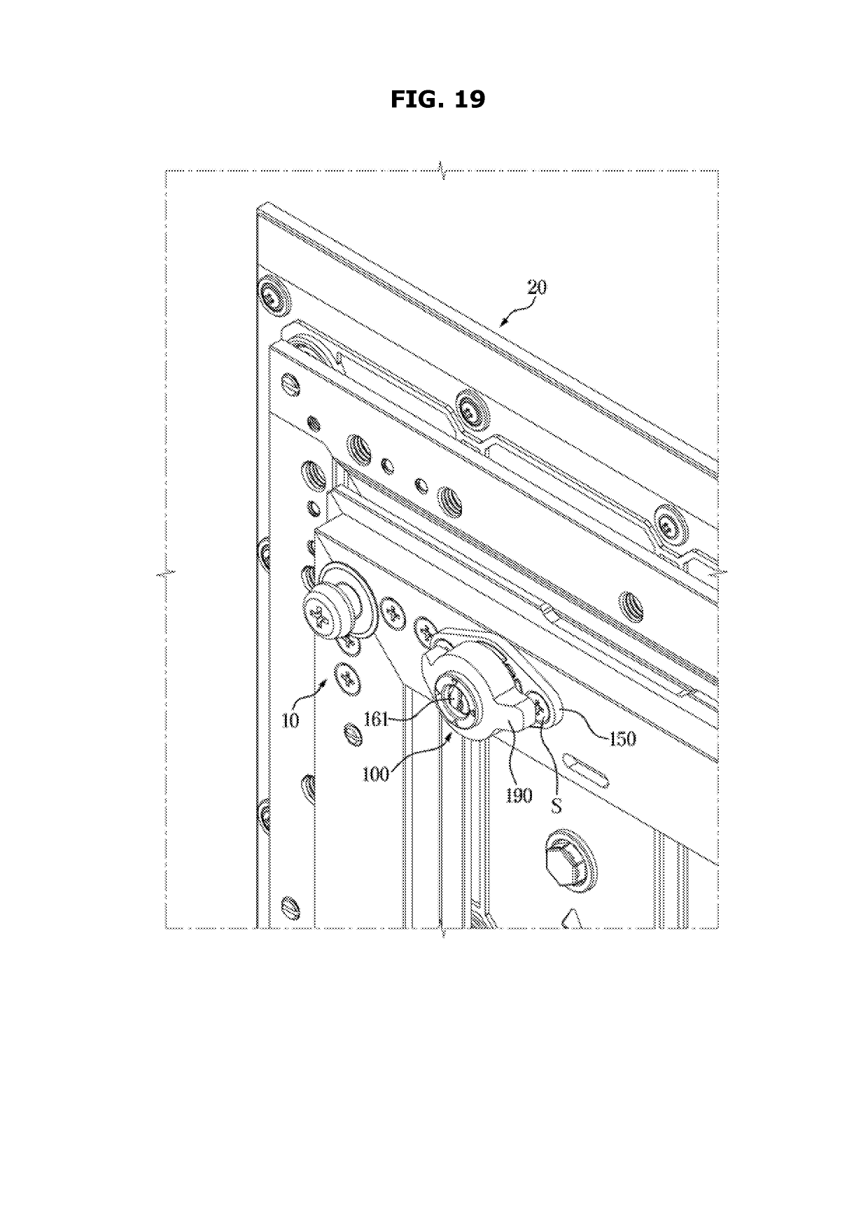

The coupling body 150 may include a coupling hole 151. The coupling hole 151 may be coupled to the frame 10 by a fastening member S (see FIG. 19). A plurality of coupling holes 151 may be formed on opposite sides of the coupling body 150. Since the coupling body 150 is coupled to the frame 10 by the fastening member S, the frame 10 may be secured (see FIG. 19).

The coupling body 150 may include a second through-hole 152. The second through-hole 152 may be formed in a central portion of the coupling body 150. The connection body 160 may pass through the second through-hole 152.

The coupling body 150 may include a plurality of first assembly holes 153. The plurality of first assembly hooks 117 of the case 110 may be connected (e.g., assembled) to the plurality of first assembly holes 153. The case 110 may be connected (e.g., assembled) to the coupling body 150 by the plurality of first assembly hooks 117 of the case 110 being connected (e.g., assembled) to the plurality of first assembly holes 153.

The coupling body 150 may include a second contact surface 154 in contact with a knob 190, which will be described later. The second contact surface 154 may be in contact with a first contact surface 193 formed on the knob 190.

The second contact surface 154 may include a third flat portion 155 formed to protrude toward and face the first contact surface 193 formed on the knob 190. The second contact surface 154 may include a second inclined portion 156 formed to be inclined in a direction opposite to a direction toward the first contact surface 193 on one side of the third flat portion 155. The second contact surface 154 may include a fourth flat portion 157 formed on one side of the second inclined portion 156. For example, the second inclined portion 156 may be between the fourth flat portion 157 and the third flat portion 155. The third flat portion 155 may be formed to protrude further than the fourth flat portion 157 toward a first contact surface 193. The second contact surface 154 will be described in more detail later.

The ball clamp 100 may include the connection body 160. The connection body 160 may be configured to penetrate the coupling body 150. The connection body 160 may penetrate the coupling body 150 through the second through-hole 152 formed in the coupling body 150. The connection body 160 penetrating the coupling body 150 may connect the ball holder 120 and the knob 190. Because the ball holder 120 and the knob 190 are connected by the connection body 160, the ball holder 120 may be moved in the first direction when the knob 190 is rotated to be moved in the first direction. This will be described in more detail later.

The connection body 160 may include a connection portion 161. The connection portion 161 may be connected to the knob 190. The connection body 160 may be connected to the knob 190 by passing through a first through-hole 191 formed in the knob 190. The connection portion 161 may be configured to have a larger diameter than a diameter of the first through-hole 191 formed in the knob 190. Because the connection portion 161 is configured to have a larger diameter than the diameter of the first through-hole 191 formed in the knob 190, the connection body 160 and the knob 190 may be connected when the connection body 160 passes through the first through-hole 191.

The connection body 160 may include the plurality of second assembly hooks 163. The plurality of second assembly hooks 163 may be connected (e.g., assembled) to the ball holder 120. The plurality of second assembly hooks 163 may be connected (e.g., assembled) to the plurality of second assembly holes 127 formed in the ball holder 120. The connection body 160 may be connected (e.g., assembled to the ball holder 120) by the plurality of second assembly hooks 163 being connected (e.g., assembled) to the plurality of second assembly holes 127 formed in the ball holder 120.

The ball clamp 100 may include an O-ring 170. The O-ring 170 may be provided on the connection body 160. The O-ring 170 may press against the knob 190.

The ball clamp 100 may include a pressing ring 180. The pressing ring 180 may be provided on the connection body 160. The pressing ring 180 may be disposed between the coupling body 150 and the O-ring 170. The pressing ring 180 may be disposed between the coupling body 150 and the O-ring 170 to press the O-ring 170.

The ball clamp 100 may include the knob 190. The knob 190 may be connected to the ball holder 120 by the connection body 160. The knob 190 connected to the connection body 160 may be rotatably provided on the coupling body 150. The knob 190 may be rotatable in contact with the coupling body 150.

The knob 190 may include the first through-hole 191. The connection body 160 may pass through the first through-hole 191. The connection body 160 that passes through the first through-hole 191 may be connected to the knob 190 by the connection portion 161 having a larger diameter than a diameter of the first through-hole 191 caught on the first through-hole 191. The first through-hole 191 may allow the knob 190 to be rotatable with respect to the connection body 160. In other words, when the knob 190 is rotated, the connection body 160 that passes through the first through-hole 191 may not rotate.

The knob 190 may include the first contact surface 193 in contact with the coupling body 150. The first contact surface 193 may be in contact with the second contact surface 154 formed on the coupling body 150.

The first contact surface 193 may include a first flat portion 195 formed to protrude toward and face the second contact surface 154 formed on the coupling body 150. The first contact surface 193 may include a first inclined portion 197 formed to be inclined in a direction opposite to a direction toward the second contact surface 154 on one side of the first flat portion 195. The first contact surface 193 may include a second flat portion 199 formed on one side of the first inclined portion 197. For example, the first inclined portion 197 may be between the second flat portion 199 and the first flat portion 195. The first flat portion 195 may be formed to protrude further than the second flat portion 199 toward the second contact surface 154. The first contact surface 193 will be described in more detail later.

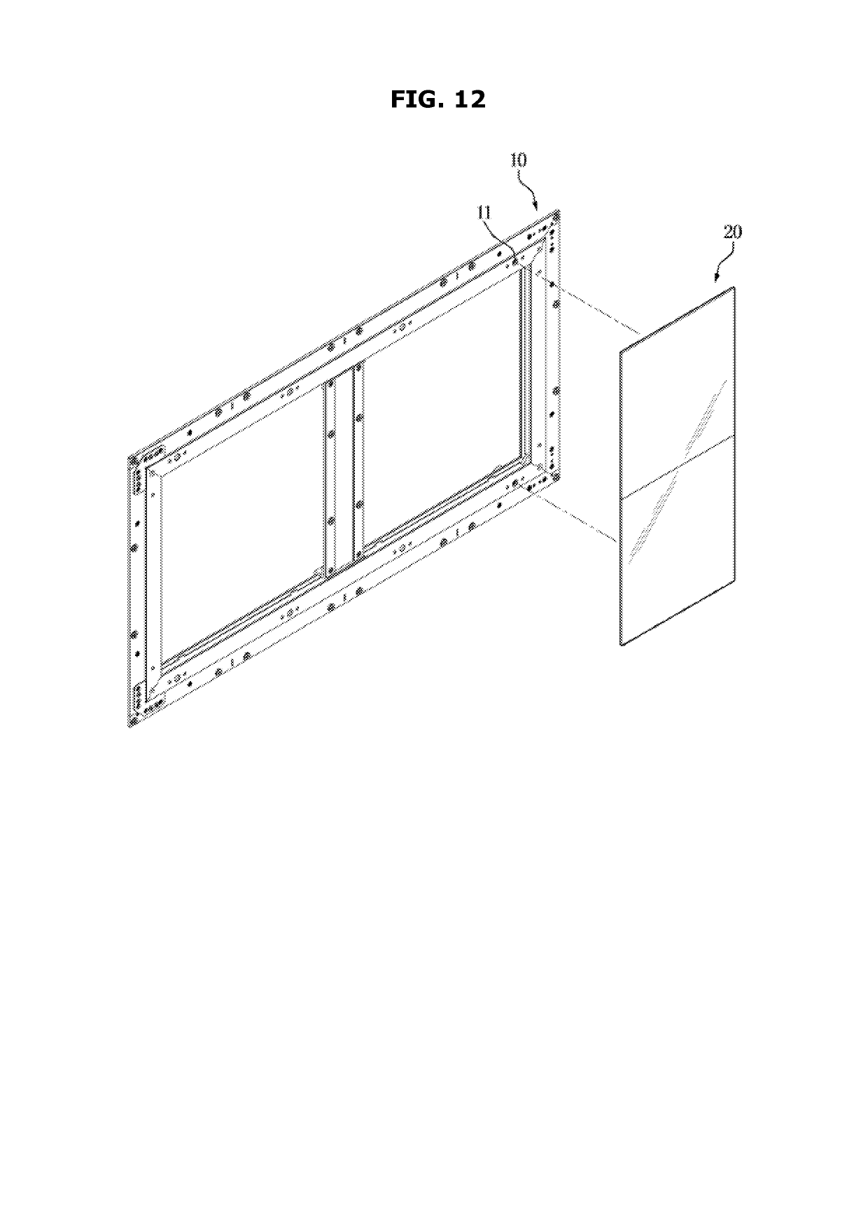

Next, an operation of assembling and/or disassembling the LED module to and/or from the frame will be described in detail with reference to FIGS. 12 to 26.

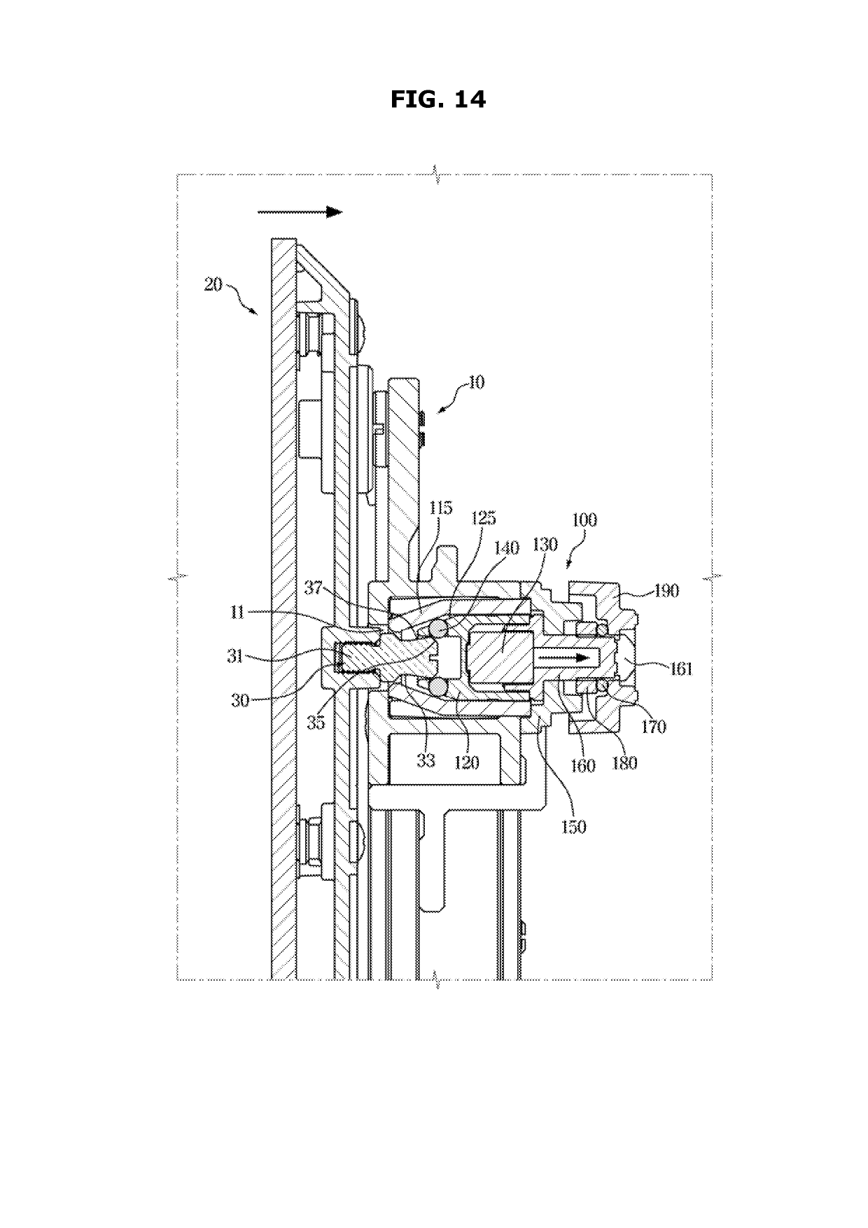

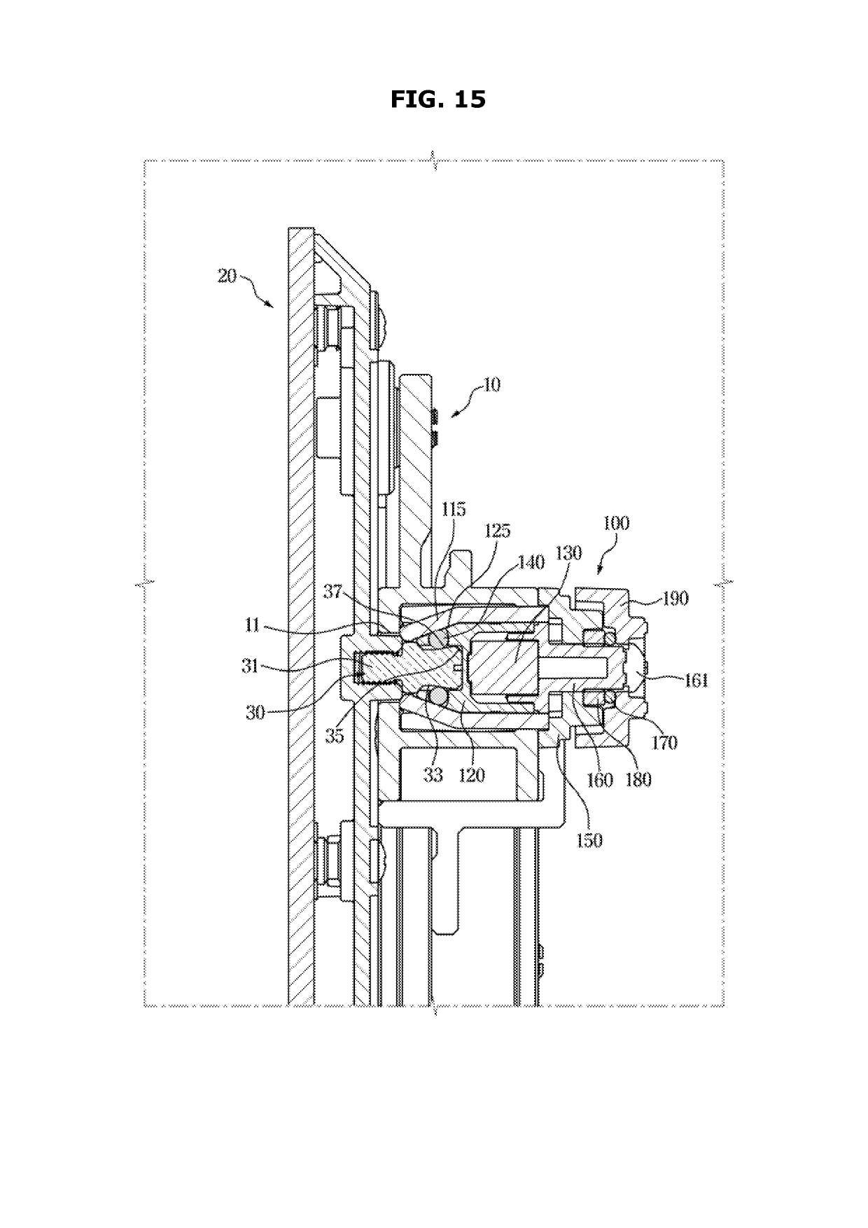

FIG. 12 is a view illustrating a state of assembling an LED module to a frame according to an embodiment. FIG. 13 is a cross-sectional view illustrating a state in which a tapered pin of an LED module is inserted into a ball clamp of a frame according to an embodiment. FIG. 14 is a cross-sectional view illustrating a state in which the ball holder has been moved in a first direction by pushing a plurality of balls as the tapered pin shown in FIG. 13 is inserted into the ball clamp. FIG. 15 is a cross-sectional view illustrating a state in which the ball holder shown in FIG. 14 has moved in a second direction by magnetic force.

As shown in FIGS. 12 and 13, the LED module 20 may be assembled to the front surface of the frame 10. The tapered pin 30 coupled to the rear surface of the LED module 20 may be inserted into the first insertion hole 113 of the case 110 (see FIG. 8) exposed to the front surface of the frame 10. The insertion portion 33 of the tapered pin 30 inserted into the first insertion hole 113 of the case 110 may be inserted into the second insertion hole 121 of the ball holder 120 (see FIG. 7). In response to the insertion portion 33 of the tapered pin 30 being inserted into the second insertion hole 121 of the ball holder 120, the push portion 35 may be in contact with the plurality of balls 140.

As shown in FIG. 14, when the tapered pin 30 is further inserted with the push portion 35 of the tapered pin 30 being in contact with the plurality of balls 140, the push portion 35 may push the plurality of balls 140. In response to the push portion 35 pushing the plurality of balls 140, the plurality of balls 140 may move in the first direction. In response to the plurality of balls 140 moving in the first direction, the ball holder 120 may move in the first direction together with the plurality of balls 140. As the ball holder 120 moves in the first direction, the connection body 160 connected to the ball holder 120 may also move in the first direction. As the connection body 160 moves in the first direction, the knob 190 connected to the connection body 160 may also move in the first direction. In response to the ball holder 120 moving in the first direction, the plurality of balls 140 in contact with the first inclined surface 115 of the case 110 (see FIG. 8) may move in the first direction along the first inclined surface 115. Because the first inclined surface 115 is formed such that the diameter thereof gradually increases in the first direction, the diameter of the circle formed by the plurality of balls 140 moving in the first direction along the first inclined surface 115 may gradually increase. For example, the plurality of balls 140 may move outwards from each other such that a diameter of the circular arrangement of the plurality of balls 140 increases. As the diameter of the circle formed by the plurality of balls 140 gradually increases, the insertion portion 33 of the tapered pin 30 may be inserted between the plurality of balls 140. When the insertion portion 33 of the tapered pin 30 is inserted between the plurality of balls 140, the ball holder 120 may come into contact with the coupling body 150 and stop moving in the first direction.

As shown in FIG. 15, when the insertion portion 33 of the tapered pin 30 is inserted between the plurality of balls 140 and movement of the tapered pin 30 in the first direction stops, the ball holder 120 may be moved in the second direction by magnetic force of the first magnet 130 attached to the ball holder 120. As the ball holder 120 moves in the second direction, the connection body 160 connected to the ball holder 120 may also move in the second direction. As the connection body 160 moves in the second direction, the knob 190 connected to the connection body 160 may also move in the second direction. In response to the ball holder 120 moving in the second direction, the plurality of balls 140 may move in the second direction along the first inclined surface 115 of the case 110. In response to the plurality of balls 140 moving in the second direction along the first inclined surface 115 of the case 110, the diameter of the circle formed by the plurality of balls 140 may gradually decrease. For example, the plurality of balls 140 may move inwards toward each other such that a diameter of the circular arrangement of the plurality of balls 140 decreases. The plurality of balls 140 may move in the second direction along the first inclined surface 115 of the case 110 while simultaneously moving along an inclined surface of the tapered portion 37 of the tapered pin 30. When the ball holder 120 moves in the second direction and comes into contact with the push portion 35 of the tapered pin 30, the ball holder 120 may stop moving in the second direction. Even when the ball holder 120 stops moving in the second direction, the magnetic force of the first magnet 130 may continuously apply a force to the ball holder 120 in the second direction, so that the plurality of balls 140 may hold the tapered portion 37 of the tapered pin 30. By the tapered portion 37 of the tapered pin 30 being held by the plurality of balls 140, the LED module 20 may be assembled to the frame 10.

As described above, by assembling the LED module 20 to the frame 10 using the magnetic force of a magnet, the LED module 20 may be easily assembled to the frame 10. Furthermore, it is possible to easily assemble the LED module 20 to the frame 10 while ensuring that the holding force of the LED module 20 remains strong.

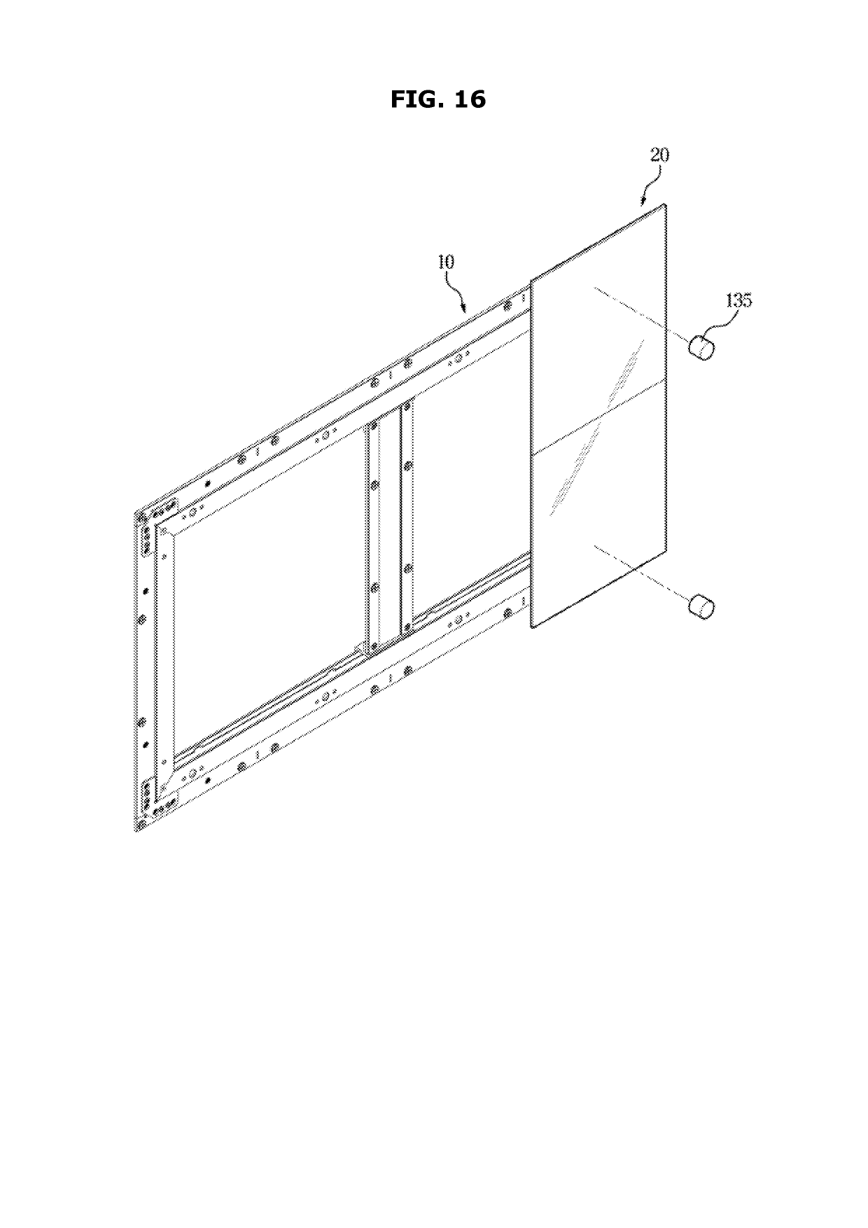

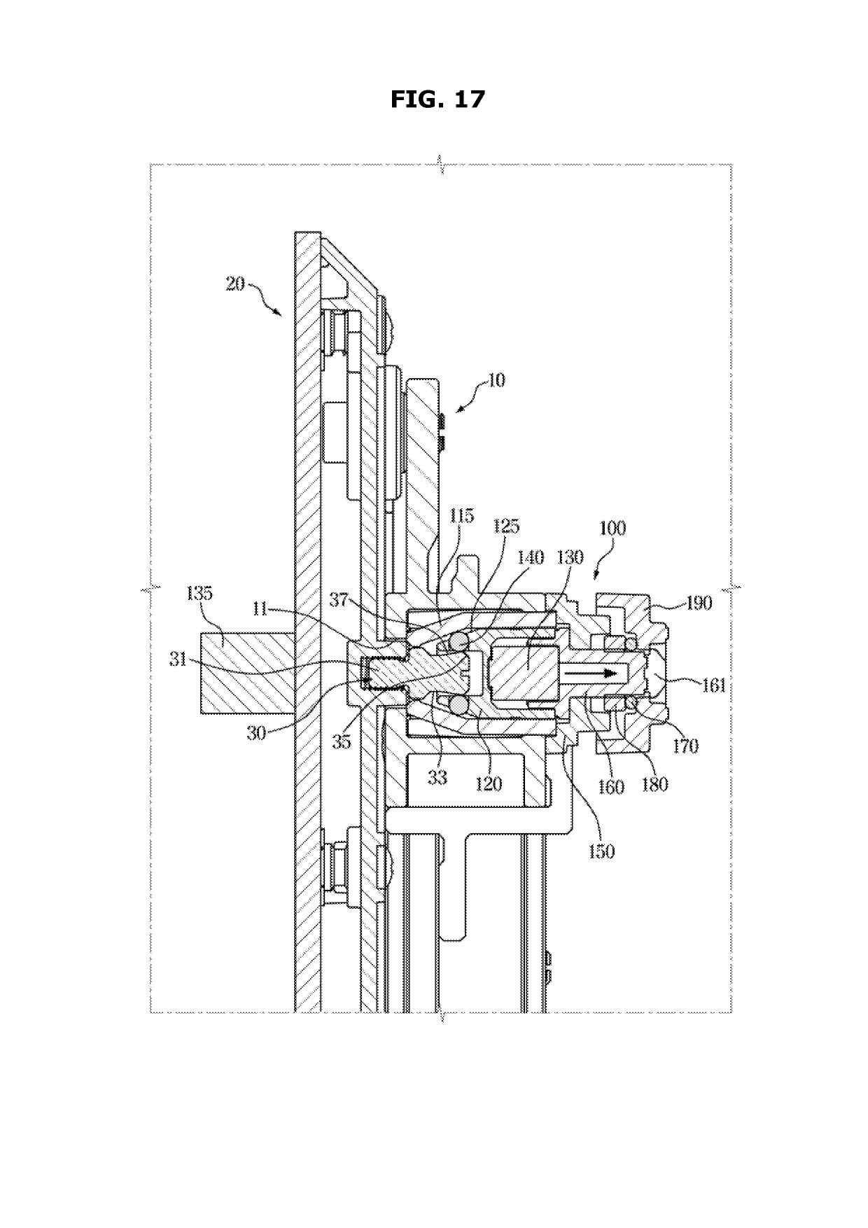

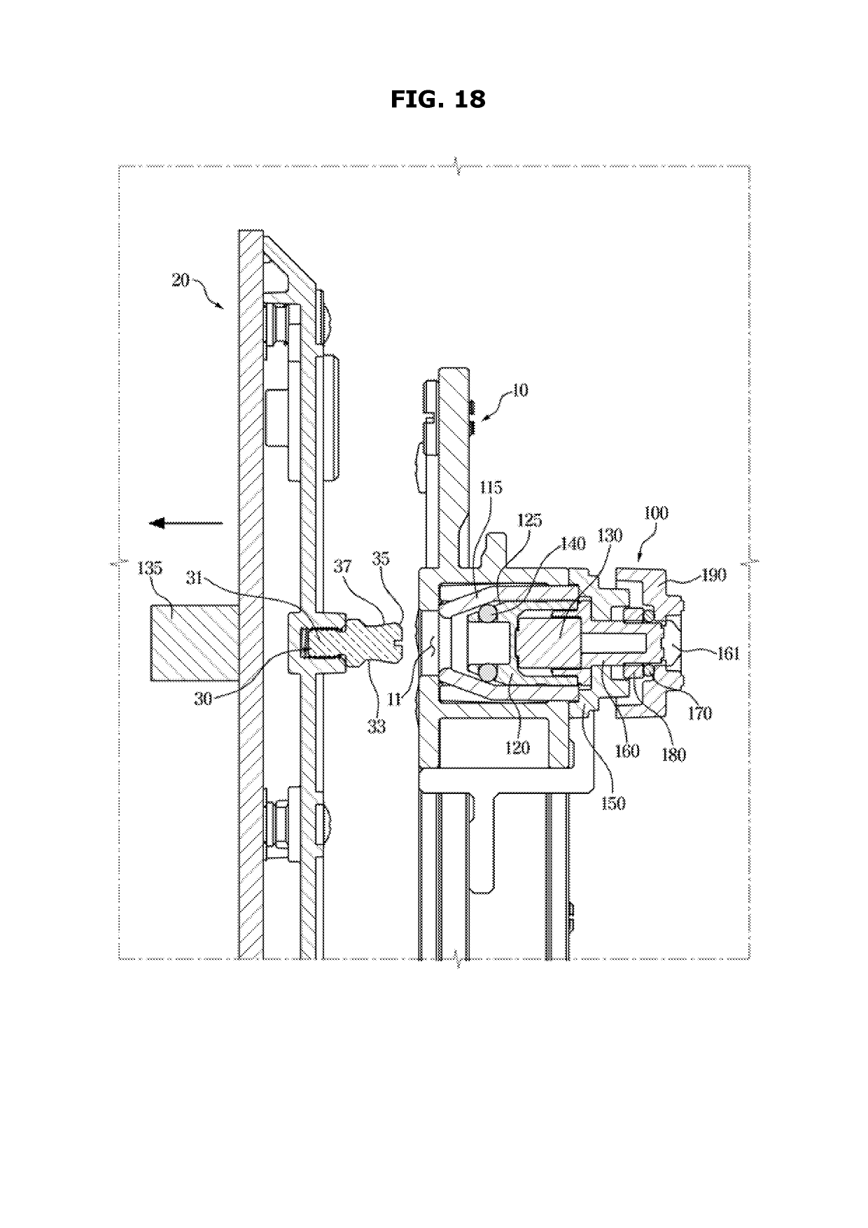

FIG. 16 is a view illustrating a state of positioning a magnet on a front surface of the LED module so as to disassemble the LED module assembled to the frame using the magnet according to an embodiment. FIG. 17 is a cross-sectional view illustrating a state in which the ball holder has been moved in a first direction by positioning the magnet on the front surface of the LED module assembled to the frame according to an embodiment. FIG. 18 is a cross-sectional view illustrating a state in which the LED module is disassembled from the frame according to an embodiment.

As shown in FIGS. 16 and 17, to separate the LED module 20 assembled to the front surface of the frame 10 from the frame 10, a second magnet 135 may be positioned on the front surface of the LED module 20. The second magnet 135 may be positioned to correspond to (e.g., overlap with) a position of the tapered pin 30 on the front surface of the LED module 20. The front surface of the LED module 20 may be opposite of a surface of the LED module 20 to which the tapered pin 30 of the LED module 20 is coupled. The second magnet 135 may be positioned to correspond to (e.g., overlap with) a position of the ball clamp 100 on the front surface of the LED module 20. The second magnet 135 may have an opposite polarity to a polarity of the first magnet 130 attached to the ball holder 120.

When the second magnet 135 is positioned on the front surface of the LED module 20, the first magnet 130 attached to the ball holder 120 may be moved away from the second magnet 135 by the magnetic force of the second magnet 135. In other words, the first magnet 130 may be moved in the first direction. When the first magnet 130 moves in the first direction, the ball holder 120 to which the first magnet 130 is attached may also move in the first direction together with the first magnet 130.

When the ball holder 120 moves in the first direction, the plurality of balls 140 provided in the ball holder 120 may move in the first direction along with the ball holder 120. The plurality of balls 140 in contact with the first inclined surface 115 of the case 110 may move in the first direction along the first inclined surface 115. Because the first inclined surface 115 is formed such that the diameter thereof gradually increases in the first direction, the diameter of the circle formed by the plurality of balls 140 moving in the first direction along the first inclined surface 115 may gradually increase. For example, the plurality of balls 140 may move outwards from each other such that a diameter of the circular arrangement of the plurality of balls 140 increases. As the diameter of the circle formed by the plurality of balls 140 gradually increases, the tapered pin 30 may be released from the plurality of balls 140. In other words, when the diameter of the circle formed by the plurality of balls 140 becomes larger than a maximum diameter of the insertion portion 33 of the tapered pin 30, the tapered pin 30 may be in a state of being unclamped from the plurality of balls 140. According to embodiments, the “circle” may refer to a virtual circle that passes through portions, of the surfaces of each of the plurality of balls 140, that face towards a center point between the plurality of balls.

When the diameter of the circle formed by the plurality of balls 140 increases and the tapered pin 30 is released from the plurality of balls 140, the LED module 20 may be separated from the frame 10, as shown in FIG. 18.

As described above, by separating the LED module 20 from the frame 10 using the magnetic force of a magnet, the LED module 20 may be easily disassembled from the frame 10.

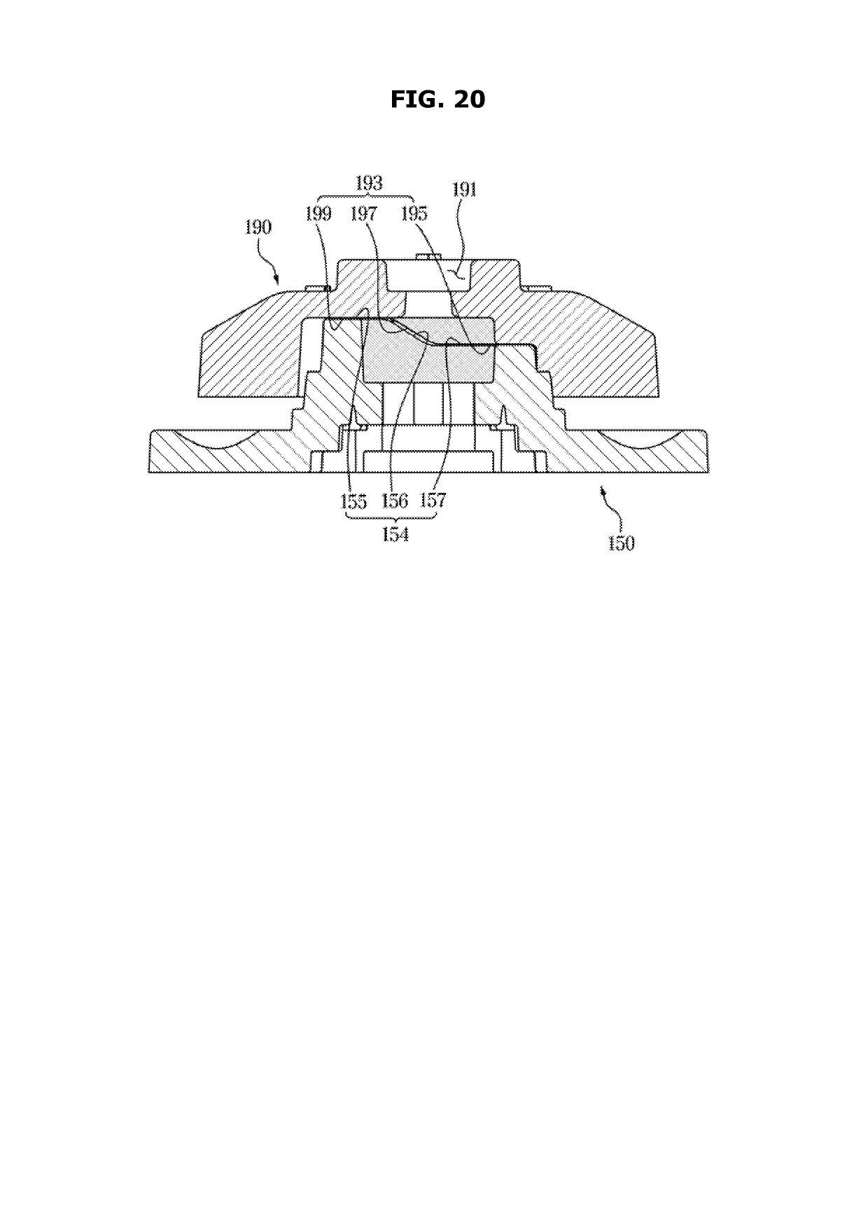

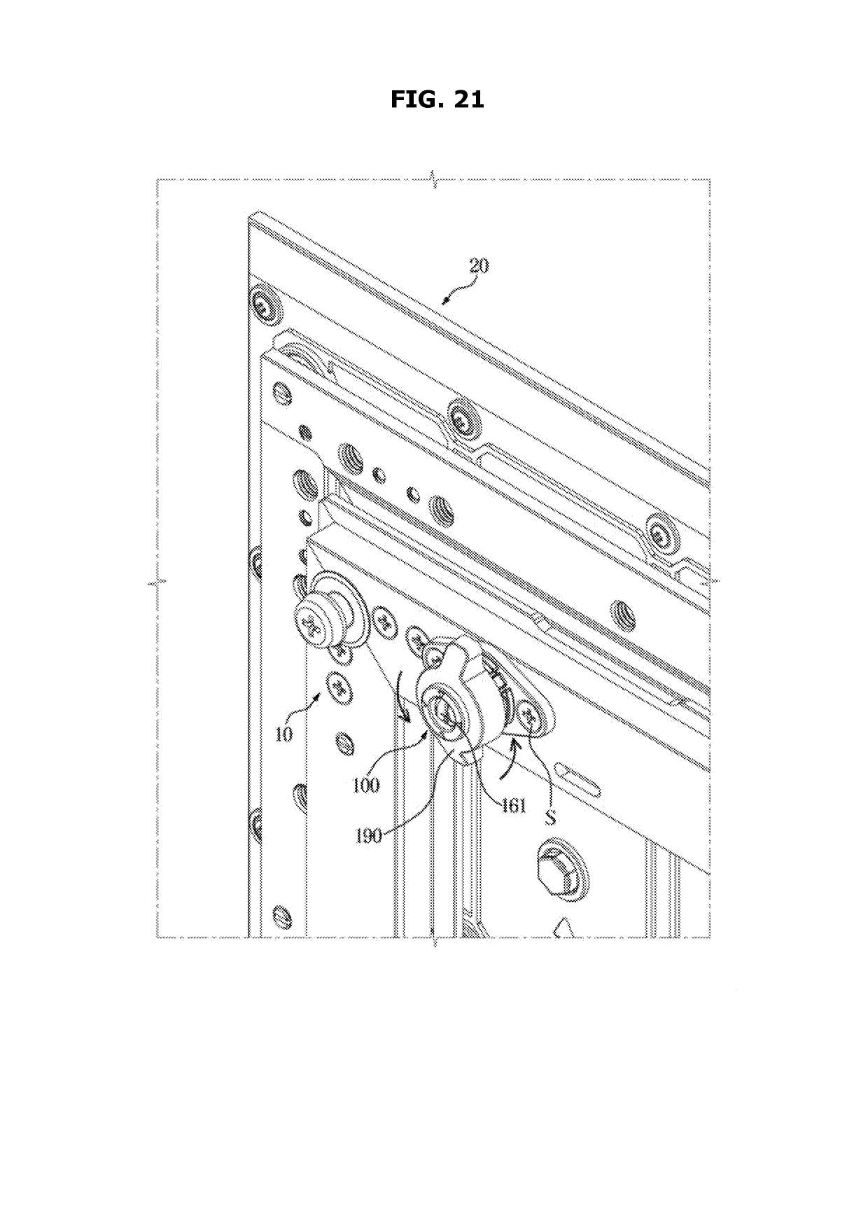

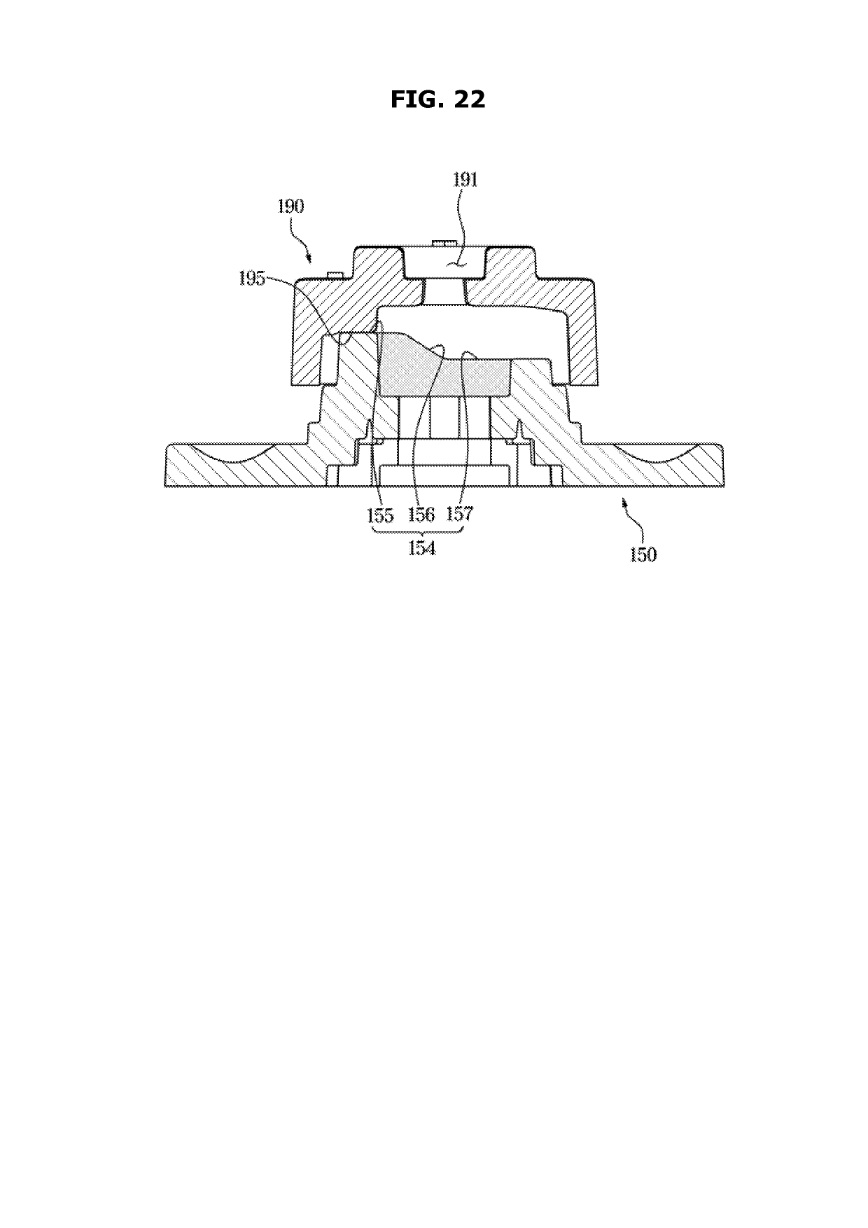

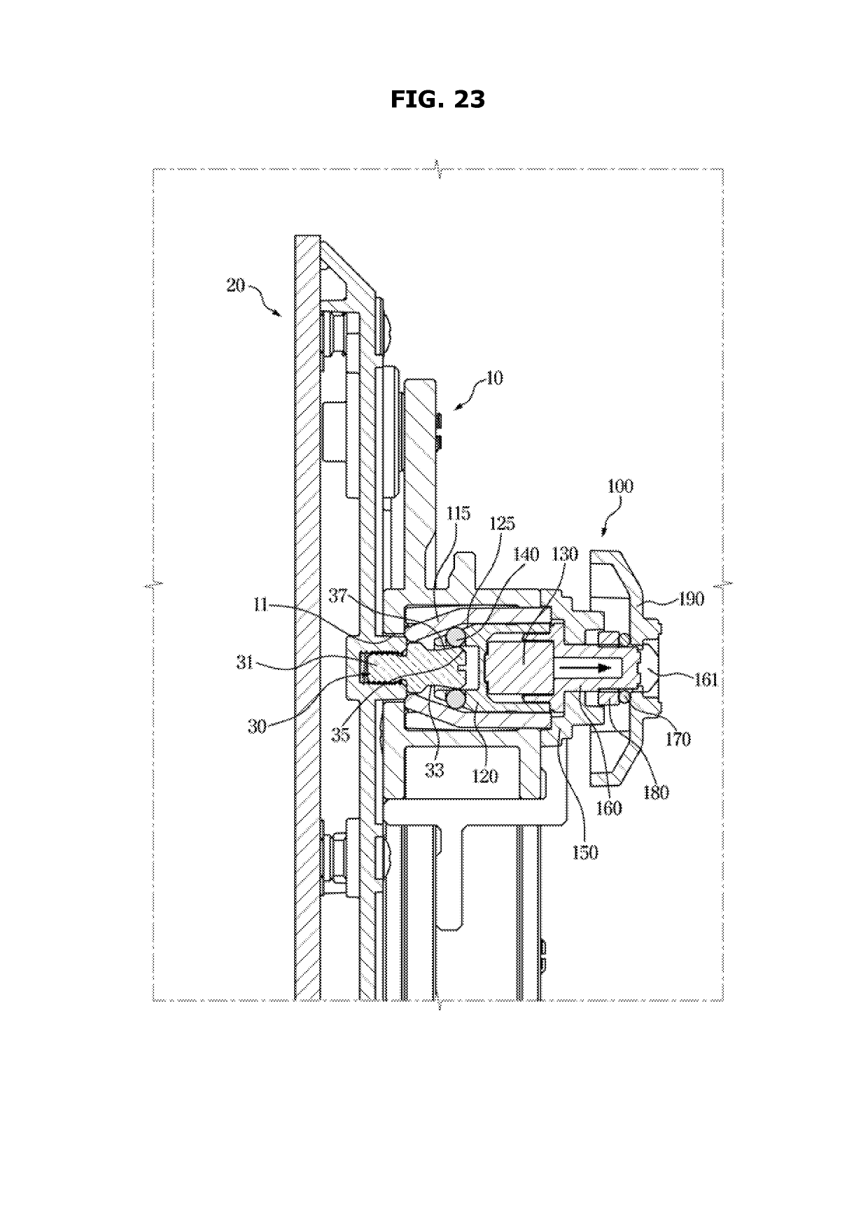

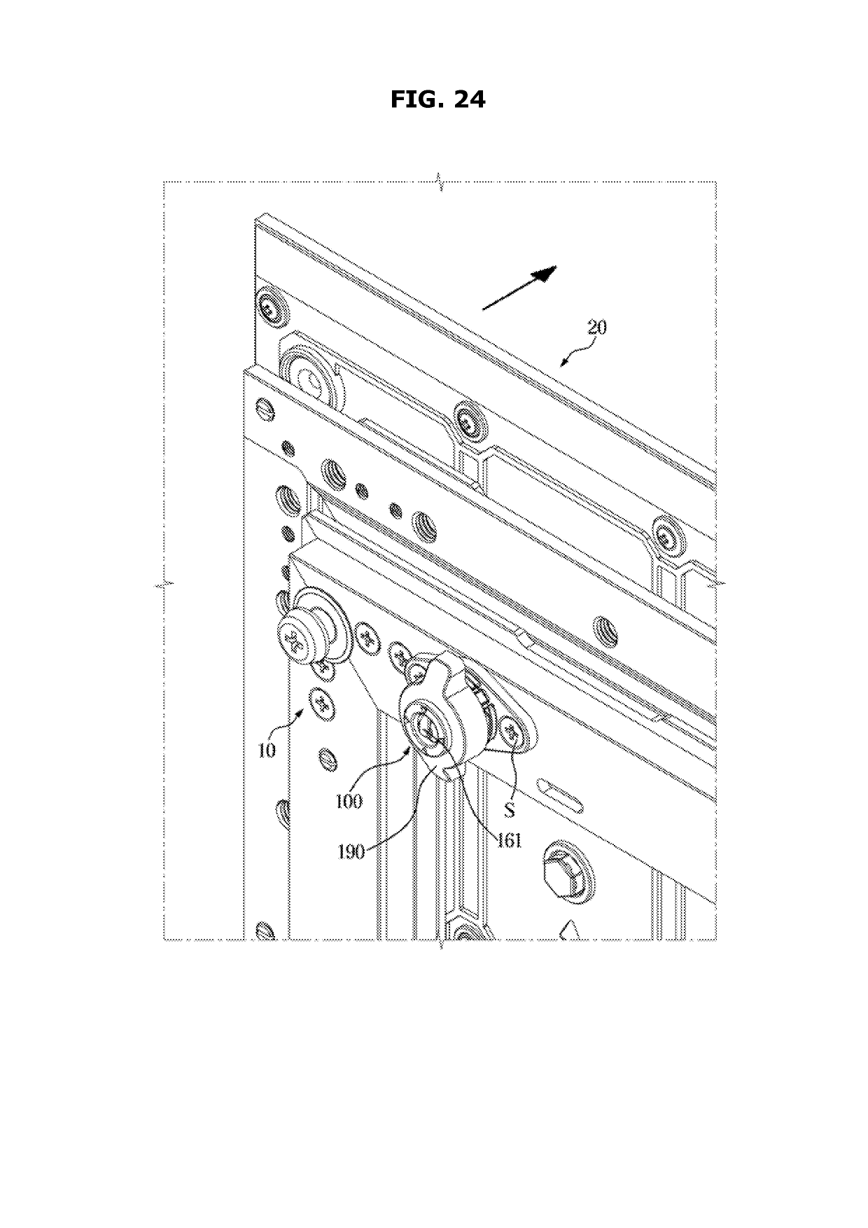

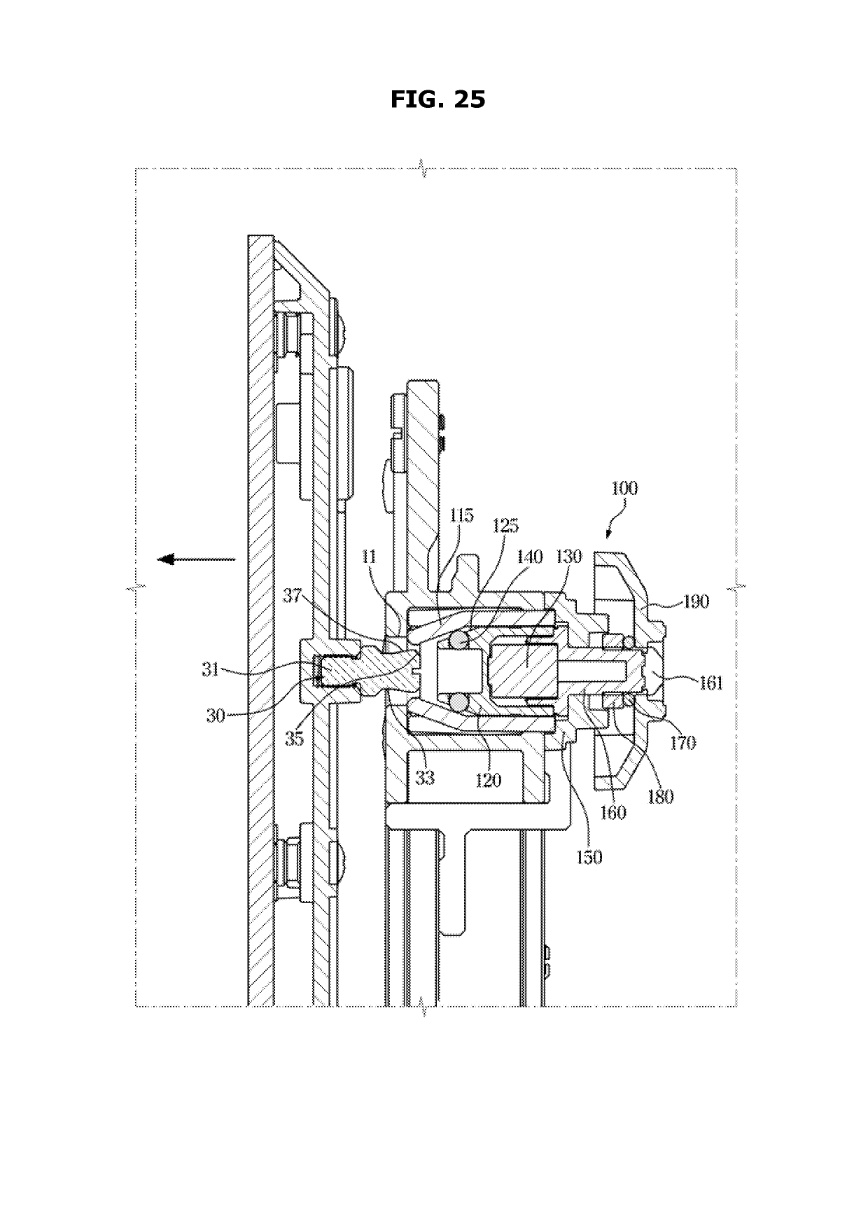

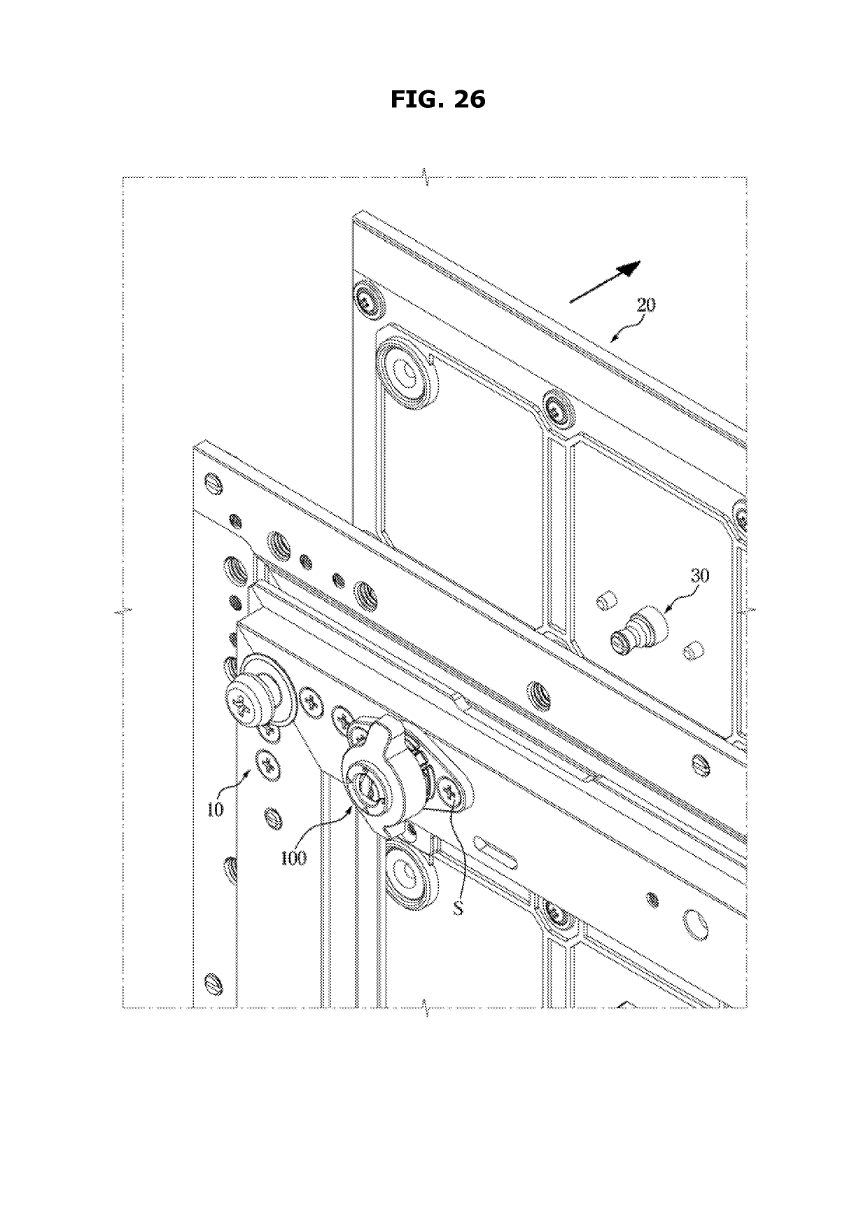

FIG. 19 is a view illustrating a state in which the LED module is assembled to the frame and the knob is in a locked state, according to an embodiment. FIG. 20 is a cross-sectional view illustrating a state in which a first contact surface of the knob and a second contact surface of the coupling body are in contact when the knob is in the locked state, according to an embodiment. FIG. 21 is a view illustrating a state in which the LED module is assembled to the frame and the knob is in an unlocked state after being rotated from the locked state, according to an embodiment. FIG. 22 is a cross-sectional view illustrating a state in which the first contact surface of the knob and the second contact surface of the coupling body are in contact when the knob is in the unlocked state, according to an embodiment. FIG. 23 is a cross-sectional view illustrating a state in which the ball holder has moved in a first direction by the knob when the knob is in the unlocked state, according to an embodiment. FIG. 24 is a view illustrating a state of disassembling the LED module from the frame when the knob is in the unlocked state, according to an embodiment. FIG. 25 is a cross-sectional view illustrating a state of disassembling the LED module from the frame when the knob is in the unlocked state, according to an embodiment. FIG. 26 is a view illustrating a state in which the LED module is disassembled from the frame when the knob is in an unlocked state, according to an embodiment.

As shown in FIGS. 19 and 20, when the LED module 20 is assembled to the frame 10 and the knob 190 is in a locked state, the tapered pin 30 coupled to the LED module 20 may be in a state of being held in the ball clamp 100 coupled to the frame 10. In other words, the tapered pin 30 may be held in the ball clamp 100 so that the LED module 20 may not be detachable from the frame 10.

When the knob 190 is in the locked state, the first contact surface 193 of the knob 190 may be in a state of being in contact with the second contact surface 154 of the coupling body 150. When the knob 190 is in the locked state, the first flat portion 195 of the first contact surface 193 of the knob 190 may be in contact with the fourth flat portion 157 of the second contact surface 154 of the coupling body 150. When the knob 190 is in the locked state, the second flat portion 199 of the first contact surface 193 of the knob 190 may be in contact with the third flat portion 155 of the second contact surface 154 of the coupling body 150. However, according to some embodiments, the first flat portion 195 and the second flat portion 199 of the first contact surface 193 of the knob 190 may not simultaneously contact the fourth flat portion 157 and the third flat portion 155 of the second contact surface 154 of the coupling body 150, respectively. For example, only the first flat portion 195 of the first contact surface 193 of the knob 190 may contact the fourth flat portion 157 of the second contact surface 154 of the coupling body 150, and the second flat portion 199 of the first contact surface 193 of the knob 190 may not contact the third flat portion 155 of the second contact surface 154 of the coupling body 150, or only the second flat portion 199 of the first contact surface 193 of the knob 190 may contact the third flat portion 155 of the second contact surface 154 of the coupling body 150, and the first flat portion 195 of the first contact surface 193 of the knob 190 may not contact the fourth flat portion 157 of the second contact surface 154 of the coupling body 150.

As shown in FIGS. 21 and 22, when the knob 190 is rotated in a state in which the LED module 20 is assembled to the frame 10, the knob 190 may be in an unlocked state. When the knob 190 is in the unlocked state, the tapered pin 30 coupled to the LED module 20 may be in a state of being released from the ball clamp 100 coupled to the frame 10. In other words, the tapered pin 30 may be released from the ball clamp 100 so that the LED module 20 may be detachable from the frame 10.

Upon rotation of the knob 190, the first flat portion 195 of the first contact surface 193 of the knob 190 may move to the third flat portion 155 along the second inclined portion 156 of the second contact surface 154 of the coupling body 150.

Upon the rotation of the knob 190, the first flat portion 195 of the first contact surface 193 of the knob 190 may move to the third flat portion 155 along the second inclined portion 156 of the second contact surface 154 of the coupling body 150 and come into contact with the third flat portion 155. The second flat portion 199 and the first inclined portion 197 of the first contact surface 193 of the knob 190 may be in a state of not being in contact with the second contact surface 154 of the coupling body 150. Because the first flat portion 195, which protrudes toward the second contact surface 154 of the coupling body 150 among portions of the first contact surface 193 of the knob 190, is in contact with the third flat portion 155, which protrudes toward the first contact surface 193 of the knob 190 among portions of the second contact surface 154 of the coupling body 150, the knob 190 may move away from the coupling body 150. In other words, the knob 190 may move in the first direction.

As shown in FIGS. 23 and 24, when the knob 190 is rotated and is in the unlocked state, the knob 190 may be in a state of having moved in the first direction. When the knob 190 moves in the first direction, the ball holder 120 connected to the knob 190 by the connection body 160 may also move in the first direction. When the ball holder 120 moves in the first direction, the plurality of balls 140 provided on the ball holder 120 may move in the first direction along with the ball holder 120. The plurality of balls 140 in contact with the first inclined surface 115 of the case 110 may move in the first direction along the first inclined surface 115. Because the first inclined surface 115 is formed such that the diameter thereof gradually increases in the first direction, the diameter of the circle formed by the plurality of balls 140 moving in the first direction along the first inclined surface 115 may gradually increase. As the diameter of the circle formed by the plurality of balls 140 gradually increases, the tapered pin 30 may be unclamped from the plurality of balls 140. In other words, when the diameter of the circle formed by the plurality of balls 140 becomes larger than the maximum diameter of the insertion portion 33 of the tapered pin 30, the tapered pin 30 may be in a state of being able to be released from the plurality of balls 140.

When the diameter of the circle formed by the plurality of balls 140 increases so that the tapered pin 30 is released from the plurality of balls 140, the LED module 20 may be separated from the frame 10, as shown in FIGS. 25 and 26.

Although not shown in the drawings, when the knob 190 is rotated back to its original position after the LED module 20 is removed from the frame 10, the ball holder 120 may be moved in the second direction by the knob 190.

As described above, by rotating the knob 190 to remove the LED module 20 from the frame 10, the LED module 20 may be easily removed from the frame 10.

A display apparatus according to an embodiment of the disclosure may include the frame 10, the LED module 20 including the tapered pin 30 assembled to the frame, and the ball clamp 100 coupled to the frame and to which the tapered pin is assembled. The ball clamp may include the case 110 including the first inclined surface 115, the ball holder 120 movably provided inside the case in a first direction in which the tapered pin is inserted and/or a second direction in which the tapered pin is disassembled, the first magnet 130 attached to the ball holder and configured to move the ball holder in the first direction and/or the second direction by a magnetic force, the plurality of balls 140 provided in the ball holder and configured to move along the first inclined surface to hold and/or release the tapered pin when the ball holder moves in the first direction and/or the second direction, and the knob configured to allow, based on the knob being rotated, the ball holder to move in the first direction to cause the plurality of balls to release the tapered pin.

The ball clamp may further include the coupling body 150 coupled to the frame, the connection body 160 configured to penetrate the coupling body and connect the ball holder and the knob, the O-ring 170 provided on the connection body and configured to press against the knob, and the pressing ring 180 disposed between the coupling body and the O-ring and pressing the O-ring.

The knob may include the first through-hole 191 through which the connection body passes, and the knob may be configured to rotate to with respect to the connection body.

The knob may include the first contact surface 193 in contact with the coupling body, and the coupling body may include the second contact surface 154 in contact with the first contact surface.

The first contact surface may include the first flat portion 195 formed to protrude toward the second contact surface, the first inclined portion 197 on one side of the first flat portion and formed to be inclined in a direction opposite to a direction toward the second contact surface, and the second flat portion 199, wherein the first inclined portion is between the first flat portion and the second flat portion.

The second contact surface may include the third flat portion 155 formed to protrude toward the first contact surface, the second inclined portion 156 on one side of the third flat portion and formed to be inclined in a direction opposite to a direction toward the first contact surface, and the fourth flat portion 157, wherein the second inclined portion is between the third flat portion and the fourth flat portion.

When the knob is in a locked state where the plurality of balls hold the tapered pin, the first flat portion of the first contact surface may be in contact with the fourth flat portion of the second contact surface and the second flat portion of the first contact surface may be in contact with the third flat portion of the second contact surface, or the first flat portion of the first contact surface may contact the fourth flat portion of the second contact surface of the coupling body while the second flat portion of the first contact surface does not contact the third flat portion of the second contact surface of the coupling body, or only the second flat portion of the first contact surface may contact the third flat portion of the second contact surface of the coupling body while the first flat portion of the first contact surface does not contact the fourth flat portion of the second contact surface of the coupling body.

Upon rotation of the knob, the first flat portion of the first contact surface may move to the third flat portion along the second inclined portion of the second contact surface.

When the knob is rotated and the first flat portion of the first contact surface comes into contact with the third flat portion of the second contact surface, the ball holder may be moved in the first direction by the knob, thereby causing the plurality of balls to release the tapered pin.

The case may include the case body 111 positioned in the frame, wherein a first side of the case body comprises a first insertion hole 113 that is open towards the LED module of the case body, and the first insertion hole is configured to receive the tapered pin, and the plurality of first assembly hooks 117 formed on a second side of the case body, opposite of the first side, and assembled to the coupling body.

The case body may include the first inclined surface, and the first inclined surface may have a diameter that increases in a direction from the first insertion hole toward the plurality of first assembly hooks.

The coupling body may include the coupling hole 151 coupled to the frame, the second through-hole 152 through which the connection body passes, and the plurality of first assembly holes 153 to which the plurality of first assembly hooks are assembled.

The ball holder may include the second insertion hole 121 formed at a position corresponding to the first insertion hole and into which the tapered pin is inserted, the second inclined surface 125 corresponding to the first inclined surface of the case, the receiving hole 123 formed in the second inclined surface and in which the plurality of balls are received, and the plurality of second assembly holes 127 to which the connection body is assembled.

The tapered pin may be formed of a magnetic material and may include the coupling portion 31 coupled to the LED module, the insertion portion 33 inserted into the first insertion hole, the push portion 35 configured to push the plurality of balls in the first direction, and the tapered portion 37 having a tapered shape and configured to be held by the plurality of balls.

The connection body may include the connection portion 161 having a larger diameter than a diameter of the first through-hole and connected to the knob, and the plurality of second assembly hooks 163 assembled to the plurality of second assembly holes.

A display apparatus according to an embodiment of the present disclosure may include the frame 10, the LED module 20 assembled to the frame, the tapered pin 30 coupled to the LED module to be assembled to the frame and formed of a magnetic material, and the ball clamp 100 coupled to the frame and to which the tapered pin is assembled. The ball clamp may include the case 110 including the first inclined surface 115, the ball holder 120 movably provided inside the case in a first direction in which the tapered pin is inserted and/or a second direction in which the tapered pin is removed, the first magnet 130 attached to the ball holder and causing the ball holder to move in the first direction and/or the second direction by a magnetic force, and the plurality of balls 140 provided in the ball holder, wherein a diameter of a circle formed by the plurality of balls is adjusted by the plurality of balls moving along the inclined surface when the ball holder moves in the first direction and/or the second direction, and the plurality of balls hold and/or release the tapered pin depending on to the diameter of the circle formed by the plurality of balls.

In response to the insertion of the tapered pin into the case, the ball holder may be moved in the first direction by the tapered pin moving the plurality of balls in the first direction, and the tapered pin may be inserted into a circle formed by the plurality of balls as a diameter of the circle, formed by the plurality of balls moved in the first direction along the first inclined surface, increases.

In response to the insertion of the tapered pin the circle formed by the plurality of balls, the ball holder may be moved in the second direction by the magnetic force of the first magnet, and the tapered pin may be held by the plurality of balls as the diameter of the circle formed by the plurality of balls decreases.

In response to the second magnet 135 with an opposite polarity from the first magnet being positioned on a surface of the LED module opposite to a surface to which the tapered pin is coupled, the ball holder may be moved in the first direction by the first magnet, and the tapered pin may be released from the plurality of balls as the diameter of the circle formed by the plurality of balls increases.

The ball clamp may further include the knob 190 rotatably provided on the frame, and the knob may be connected to the ball holder so that when the knob is rotated, the ball holder may be moved in the first direction and/or the second direction.

According to some embodiments of the disclosure, the assembly and/or disassembly of the LED module can be facilitated.

Furthermore, it is possible to maintain a strong holding force of the LED module assembled to the frame.

Furthermore, installation and maintenance work of the LED module can be performed quickly and efficiently.

Furthermore, stability and durability of the display apparatus can be improved by strengthening a holding force of the assembled LED module.

Furthermore, since the LED module is disassembled from the frame by magnetic force from the front surface of the LED module, the LED modules may have a fine pitch.

Aspects and effects of embodiments of the disclosure are not limited to the aspects and effects mentioned above, and other unmentioned aspects effects can be clearly understood by those of ordinary skill in the art to which the present disclosure pertains from the description above.

While non-limiting example embodiments of the disclosure have been particularly described with reference to the accompanying drawings, it should be understood by those of skilled in the art that various changes in form and details may be made without departing from the spirit and scope of the disclosure.

What is claimed is:

1. A display apparatus, comprising:
a frame;
a light-emitting diode (LED) module comprising a tapered pin; and
a ball clamp configured to connect the frame and the LED module by the tapered pin being inserted into the ball clamp in a first direction;
wherein the ball clamp comprises:
a case comprising a first inclined surface;
a ball holder configured to move inside the case in the first direction or a second direction, opposite to the first direction, based on the tapered pin being inserted into the ball clamp in the first direction or removed from the ball clamp in the second direction;
a magnet attached to the ball holder and configured to move the ball holder in the first direction or the second direction by a magnetic force;
a plurality of balls in the ball holder, the plurality of balls configured to hold the tapered pin by the plurality of balls moving along the first inclined surface when the ball holder moves in the second direction, or release the tapered pin by the plurality of balls moving along the first inclined surface when the ball holder moves in the first direction; and
a knob configured to allow, based on the knob being rotated, the ball holder to move in the first direction to cause the plurality of balls to release the tapered pin .

2. The display apparatus of claim 1, wherein the ball clamp further comprises:
a coupling body configured to be connected to the frame;
a connection body configured to penetrate the coupling body and connect the ball holder and the knob;
an O-ring on the connection body and configured to press against the knob; and
a pressing ring between the coupling body and the O-ring and configured to press the O-ring.

3. The display apparatus of claim 2, wherein
the knob comprises a first through-hole,
the connection body is in the first through-hole, and
the knob is configured to rotate with respect to the connection body.

4. The display apparatus of claim 3, wherein
the knob comprises a first contact surface, and
the coupling body comprises a second contact surface that is configured to contact the first contact surface.

5. The display apparatus of claim 4, wherein the first contact surface comprises:
a first flat portion protruding toward the second contact surface;
a first inclined portion on a side of the first flat portion, the first inclined portion being inclined in a third direction away from the second contact surface; and
a second flat portion,
wherein the first inclined portion is between the first flat portion and the second flat portion.

6. The display apparatus of claim 5, wherein the second contact surface comprises:
a third flat portion protruding toward the first contact surface;
a second inclined portion on a side of the third flat portion, the second inclined portion being inclined in a fourth direction away from the first contact surface; and
a fourth flat portion,
wherein the second inclined portion is between the third flat portion and the fourth flat portion.

7. The display apparatus of claim 6, wherein
the knob is configured to be in a locked state in which the plurality of balls hold the tapered pin and, in the locked state:
the first flat portion of the first contact surface is in contact with the fourth flat portion of the second contact surface and the second flat portion of the first contact surface is in contact with the third flat portion of the second contact surface; or
the first flat portion of the first contact surface is in contact with the fourth flat portion of the second contact surface and the second flat portion of the first contact surface is not in contact with the third flat portion of the second contact surface; or
the second flat portion of the first contact surface is in contact with the third flat portion of the second contact surface and the first flat portion of the first contact surface is not in contact with the fourth flat portion of the second contact surface.

8. The display apparatus of claim 7, wherein
based on the knob rotating, the first flat portion of the first contact surface moves to the third flat portion along the second inclined portion of the second contact surface.

9. The display apparatus of claim 8, wherein
when the knob is rotated and the first flat portion of the first contact surface comes into contact with the third flat portion of the second contact surface, the plurality of balls are configured to release the tapered pin based on the ball holder moving in the first direction due to the knob.

10. The display apparatus of claim 3, wherein the case comprises:
a case body in the frame, wherein a first side of the case body comprises a first insertion hole that is open towards the LED module of the case body, and the first insertion hole is configured to receive the tapered pin; and
a first assembly hook on a second side of the case body, opposite of the first side, and the first assembly hook is configured to be connected to the coupling body.

11. The display apparatus of claim 10, wherein
the case body comprises the first inclined surface, and the first inclined surface has a diameter that increases in a third direction from the first insertion hole toward the first assembly hook.

12. The display apparatus of claim 10, wherein the coupling body comprises:
a coupling hole that is configured to receive a portion of the frame;
a second through-hole through which the connection body passes; and
a first assembly hole that is configured to receive the first assembly hook.

13. The display apparatus of claim 12, wherein the ball holder comprises:
a second insertion hole that is configured to overlap with the first insertion hole and receive the tapered pin;
a second inclined surface overlapping with the first inclined surface of the case;
at least one receiving hole in the second inclined surface, the at least one receiving hole configured to receive the plurality of balls; and
a second assembly hole that is configured to receive a portion of the connection body.

14. The display apparatus of claim 13, wherein
the tapered pin is formed of a magnetic material, and
the tapered pin comprises:
a coupling portion that is configured to connect to the LED module;
an insertion portion configured to be inserted into the first insertion hole;
a push portion configured to push the plurality of balls in the first direction; and
a tapered portion configured to be held by the plurality of balls.

15. The display apparatus of claim 13, wherein the connection body comprises:
a connection portion configured to be connected to the knob, wherein a diameter of the connection portion is larger than a diameter of the first through-hole; and
a second assembly hook configured to be inserted into the second assembly hole.

16. A display apparatus comprising:
a frame;
a light-emitting diode (LED) module comprising a tapered pin, the tapered pin comprising a magnetic material; and
a ball clamp configured to connect the frame and the LED module by the tapered pin being inserted into the ball clamp in a first direction,
wherein the ball clamp comprises:
a case comprising a first inclined surface;
a ball holder configured to move inside the case in the first direction or a second direction, opposite to the first direction, based on the tapered pin being inserted into the ball clamp in the first direction or removed from the ball clamp in the second direction;
a first magnet attached to the ball holder and configured to move the ball holder in the first direction or the second direction by a magnetic force, and
a plurality of balls in the ball holder, the plurality of balls configured to hold the tapered pin by the plurality of balls moving along the first inclined surface when the ball holder moves in the second direction, or release the tapered pin by the plurality of balls moving along the first inclined surface when the ball holder moves in the first direction,
wherein the plurality of balls are in a circular arrangement, and
wherein the plurality of balls are configured to hold the tapered pin based on a diameter of the circular arrangement decreasing, or release the tapered pin based on the diameter of the circular arrangement increasing.

17. The display apparatus of claim 16, wherein, based on the tapered pin being inserted into the case:
the ball holder moves in the first direction due to the tapered pin moving the plurality of balls in the first direction;
the diameter of the circular arrangement of the plurality of balls increases based on the plurality of balls moving in the first direction along the first inclined surface; and
the tapered pin is inserted into the circular arrangement of the plurality of balls.

18. The display apparatus of claim 17, wherein, based on the tapered pin moving into the circular arrangement of the plurality of balls:
the ball holder moves in the second direction due to the magnetic force of the first magnet; and
the tapered pin becomes held by the plurality of balls, based on the diameter of the circular arrangement of the plurality of balls decreasing.

19. The display apparatus of claim 18, based on a second magnet having a polarity opposite of a polarity of the first magnet being positioned on a surface of the LED module in a state where the tapered pin is held by the plurality of balls:
the first magnet moves, due to a magnetic force of the second magnet, the ball holder in the first direction; and
the tapered pin is released by the plurality of balls, based on the diameter of the circular arrangement of the plurality of balls increasing.

20. The display apparatus of claim 16, wherein the ball clamp further comprises a knob that is connected to the ball holder, the knob being configured to rotate on the frame, and
wherein the knob is further configured to, due to rotation of the knob, allow the ball holder to move in the first direction or the second direction.
